(19) United States
(12) Patent Application Publication
(10) Pub. No.: US 2024/0129667 A1
(43) Pub. Date: Apr. 18, 2024

(54) AUTOMATIC PROCESSING STATE CONTROL OF A MICROPHONE OF A LISTENING DEVICE

(71) Applicant: Caavo Inc, Milpitas, CA (US)

(72) Inventors: Ashish D. Aggarwal, Stevenson Ranch, CA (US); Vinod K. Gopinath, Bangalore (IN); Karthik Shrinarsi, Bangalore (IN); Sharath H. Satheesh, Bangalore (IN)

(21) Appl. No.: 18/486,219

(22) Filed: Oct. 13, 2023

(30) Foreign Application Priority Data
Oct. 15, 2022 (IN) 202241058997

(51) Int. Cl. H04R 3/00; G06F 3/16; H04R 1/40; H04R 29/00

(52) U.S. Cl. CPC H04R 3/005; G06F 3/162; H04R 1/406; H04R 29/005

(57) ABSTRACT

Systems and methods are described for automatic processing state control of a microphone of a listening device. A signal is received. A first event is detected based on an analysis of the signal. A determination to enable processing of audio captured by a microphone of a listening device is made based at least on the detected first event. Responsive to said determination, a first command is transmitted to the listening device. The first command includes instructions to enable processing of the audio captured by the microphone. In a further aspect, a determination to cease processing of audio captured by the microphone is made based on a detected second event. Responsive to the determination to cease processing, a second command is transmitted to the listening device to cease processing audio captured by the microphone.

### CROSS-REFERENCE TO RELATED APPLICATIONS

This application claims priority to India Provisional Application No. 202241058997, filed on Oct. 15, 2022, entitled “AUTOMATIC POWER STATE CONTROL OF A MICROPHONE OF A REMOTE CONTROL DEVICE,” which is incorporated by reference herein in its entirety.

### BACKGROUND

Devices in a living room may be controlled by a remote control device (“remote”). These remotes may be battery powered and include a microphone. In order to conserve battery power, conventional remotes often include push-to-talk buttons to enable and disable the microphone as needed. As a result, the user needs to have the remote control device in hand or within reach to press the push-to-talk button to enable the microphone.

### BRIEF SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

Methods, systems, and apparatuses are described for the automatic control of a processing state of a microphone of a listening device. In one aspect, a system comprises an event detector and a microphone control component. The event detector receives a first signal and detects a first event based on an analysis of the first signal. The microphone control component determines to enable processing of audio captured by a first microphone of a listening device based at least on the detected event. Responsive to the determination, the microphone control component transmits a first command to the listening device. The first command includes instructions to enable processing of the audio captured by the first microphone.

In a further aspect, the transmission of the first command to the listening device causes the listening device to provide power to the first microphone to cause the first microphone to capture the audio. The system comprises an interface that receives, from the listening device, the audio captured by the first microphone.

In a further aspect, the transmission of the first command to the listening device causes the listening device to provide audio captured by the first microphone to an application executing on a network device for processing thereof.

In a further aspect, the microphone control component compares an audio signal captured by the first microphone to an expected audio output of a media presentation device. The microphone control component determines whether a level of similarity between the audio signal and the expected audio output meets a threshold condition. In response to a determination that the level of similarity between the audio signal and the expected audio output meets the threshold condition, the microphone control component determines processing of the audio captured by the first microphone is enabled. In response to a determination that the level of similarity between the audio signal and the expected audio output does not meet the threshold condition, the microphone control component performs a corrective action.

In a further aspect, the system comprises a user presence determiner that determines a user is present based on an analysis of data. In this aspect, the microphone control component determines to enable processing of audio captured by the first microphone based at least on the detected first event and the determination that the user is present.

### BRIEF DESCRIPTION OF THE DRAWINGS/FIGURES

The accompanying drawings, which are incorporated herein and form a part of the specification, illustrate embodiments and, together with the description, further serve to explain the principles of the embodiments and to enable a person skilled in the pertinent art to make and use the embodiments.

FIG. 1 is a block diagram of a system configured to automatically control the processing state of a microphone of a listening device, according to an exemplary embodiment.

FIG. 2 is a block diagram of a media system configured to automatically control the processing state of a microphone of a listening device, according to an exemplary embodiment.

FIG. 3 is a block diagram of a media system configured to automatically control the processing state of a microphone of a listening device, according to another exemplary embodiment.

FIG. 4 is a block diagram of a system configured to automatically control the processing state of a microphone of a listening device, according to another exemplary embodiment.

FIG. 5A is a flowchart of a process for automatic processing state control of a microphone of a listening device, according to an exemplary embodiment.

FIG. 5B is a flowchart of a process for enabling processing of audio captured by a microphone of a listening device, according to an exemplary embodiment.

FIG. 5C is a flowchart of a process for enabling processing of audio captured by a microphone of a listening device, according to another exemplary embodiment.

FIG. 6A is a flowchart of a process for determining a processing state of a microphone of a listening device, according to an exemplary embodiment.

FIG. 6B is a block diagram of a system for determining a processing state of a microphone of a listening device, according to an exemplary embodiment.

FIG. 7 is a flowchart of a process for determining whether to accept an incoming call, according to an exemplary embodiment.

FIG. 8 is a flowchart of a process for automatic processing state control of a microphone of a listening device based on determining a user presence, according to an exemplary embodiment.

FIG. 9 is a block diagram of a system for automatic processing state control of a microphone of a listening device based on determining a user presence, according to an exemplary embodiment.

FIG. 10A is a flowchart of a process for ceasing processing of audio captured by a microphone of a listening device, according to an exemplary embodiment.

FIG. 10B is a flowchart of a process for ceasing processing of audio captured by a microphone of a listening device, according to another exemplary embodiment.

FIG. 10C is a flowchart of a process for ceasing processing of audio captured by a microphone of a listening device, according to another exemplary embodiment.

FIG. 11 is a block diagram of a media system configured to automatically control the processing state of a microphone of a listening device, according to another exemplary embodiment.

FIG. 12 is a block diagram of a media system configured to automatically control the processing state of a microphone of a listening device, according to another exemplary embodiment.

FIG. 13 is a block diagram of a computer system, according to an exemplary embodiment.

Embodiments will now be described with reference to the accompanying drawings. In the drawings, like reference numbers indicate identical or functionally similar elements. Additionally, the left-most digit(s) of a reference number identifies the drawing in which the reference number first appears.

### DETAILED DESCRIPTION

### I. Introduction

The present specification discloses numerous example embodiments. The scope of the present patent application is not limited to the disclosed embodiments, but also encompasses combinations of the disclosed embodiments, as well as modifications to the disclosed embodiments.

References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

Furthermore, it should be understood that spatial descriptions (e.g., “above,” “below,” “up,” “left,” “right,” “down,” “top,” “bottom,” “vertical,” “horizontal,” etc.) used herein are for purposes of illustration only, and that practical implementations of the structures described herein can be spatially arranged in any orientation or manner.

Numerous exemplary embodiments are described herein. Any section/subsection headings provided herein are not intended to be limiting. Embodiments are described throughout this document, and each embodiment may be eligible for inclusion within multiple different sections or subsections. Furthermore, it is contemplated that the disclosed embodiments may be combined with each other in any manner. That is, the embodiments described herein are not mutually exclusive of each other and may be practiced and/or implemented alone, or in any combination.

A system is described herein. The system comprises an event detector and a microphone control component. The event detector receives a first signal and detects a first event based on an analysis of the first signal. The microphone control component determines to enable processing of audio captured by a first microphone of a listening device based at least on the detected first event. Responsive to the determination, the microphone control component transmits a first command to the listening device. The first command includes instructions to enable processing of the audio captured by the first microphone.

In an implementation of the foregoing system, the first signal comprises at least one of: a media content signal that is provided to a media presentation device that presents media content based on the media content signal; an audio signal captured by a second microphone that is proximate to the media presentation device; a network signal received by a network interface; or an image or a video of the media presentation device captured by a camera.

In an implementation of the foregoing system, the transmission of the first command to the listening device causes the listening device to provide power to the first microphone to cause the first microphone to capture the audio; and the system comprises an interface that receives, from the listening device, the audio captured by the first microphone.

In an implementation of the foregoing system, the transmission of the first command to the listening device causes the listening device to provide audio captured by the first microphone to an application executing on a network device for processing thereof.

In an implementation of the foregoing system, the event detector compares an audio signal captured by the first microphone to an expected audio output of a media presentation device. The event detector determines whether a level of similarity between the audio signal and the expected audio output meets a threshold condition. In response to a determination that the level of similarity between the audio signal and the expected audio output meets the threshold condition, the event detector determines processing of the audio captured by the first microphone is enabled. In response to a determination that the level of similarity between the audio signal and the expected audio output does not meet the threshold condition, the event detector performs a corrective action.

In an implementation of the foregoing system, the detected first event comprises one of: an incoming audio or video call; an indication that an audio input feature of an application has been enabled; a determination that an application is in a state to accept user input; or launching of an application with audio input features.

In an implementation of the foregoing system, the detected first event comprises the incoming call and the system comprises an interface that receives, from the listening device, an audio signal captured by the first microphone while the first microphone is on. The event detector determines whether to accept the incoming call based at least on the audio signal.

In an implementation of the foregoing system, the system comprises a user presence determiner that determines a user is present based on an analysis of data. In this aspect, the microphone control component determines to enable processing of audio captured by the first microphone based at least on the detected first event and the determination that the user is present.

In an implementation of the foregoing system, the user presence determiner determines a user is present based at least on one of: an analysis of an image or a video of the user captured by a camera; an analysis of an output of a sensor of the listening device; an analysis of data obtained from a smart home application associated with the user; or an analysis of an output of a motion detector.

In an implementation of the foregoing system, the microphone control component further: determines to cease processing audio captured by the first microphone based on at least one of: the event detector detecting a second event, the event detector determining a caller is speaking, or the microphone control component identifying a period of inactivity by monitoring the audio captured by the first microphone. The microphone control component transmits a second command to the listening device. The second command includes instructions to cease processing audio captured by the first microphone on behalf of the system.

In an implementation of the foregoing system, the listening device comprises at least one of: a remote control device; or a smart home device.

A method is described herein. The method comprises: receiving a first signal; detecting a first event based on an analysis of the first signal; determining to enable processing of audio captured by a first microphone of a listening device based at least on the detected first event; and responsive to said determining, transmitting a first command to the listening device, the first command including instructions to enable processing of the audio captured by the first microphone.

In an implementation of the foregoing method, the first signal comprises at least one of: a media content signal that is provided to a media presentation device that presents media content based on the media content signal; an audio signal captured by a second microphone that is proximate to the media presentation device; a network signal received by a network interface; or an image or a video of the media presentation device captured by a camera.

In an implementation of the foregoing method, said transmitting the first command to the listening device causes the listening device to: provide power to the first microphone to cause the first microphone to capture the audio; and the method further comprises: receiving the audio captured by the first microphone from the listening device.

In an implementation of the foregoing method, said transmitting the first command to the listening device causes the listening device to: provide audio captured by the first microphone to an application executing on a network device for processing thereof.

In an implementation of the foregoing method, the method further comprises: comparing an audio signal captured by the first microphone to an expected audio output of a media presentation device; determining whether a level of similarity between the audio signal and the expected audio output meets a threshold condition; in response to determining that the level of similarity between the audio signal and the expected audio output meets the threshold condition, determining that processing of the audio captured by the first microphone is enabled; and in response to determining that the level of similarity between the audio signal and the expected audio output does not meet the threshold condition, performing a corrective action.

In an implementation of the foregoing method, the detected first event comprises one of: an incoming audio or video call; an indication that an audio input feature of an application has been enabled; a determination that an application is in a state to accept user input; or launching of an application with audio input features.

In an implementation of the foregoing method, the detected first event comprises the incoming call; and the method further comprises: receiving, from the listening device, an audio signal captured by the first microphone while the first microphone is on; and determining whether to accept the incoming call based at least on the audio signal.

In an implementation of the foregoing method, said determining to enable processing of audio captured by the first microphone based at least on the detected first event comprises: determining a user is present based on at least one of: an analysis of an image or a video of the user captured by a camera; an analysis of an output of a sensor of the listening device; an analysis of data obtained from a smart home application associated with the user; or an analysis of an output of a motion detector; and determining to enable processing of audio captured by the first microphone based at least on the detected first event and the determination that the user is present.

In an implementation of the foregoing method, the method further comprises: detecting a second event; determining to cease processing audio captured by the first microphone based at least on the detected second event; and transmitting a second command to the listening device, the second command including instructions to cease processing audio captured by the first microphone.

In an implementation of the foregoing method, the method further comprises: determining that a caller is speaking; and in response to determining that the caller is speaking, transmitting a second command to the listening device, the second command including instructions to cease processing audio captured by the first microphone.

In an implementation of the foregoing method, the method further comprises: identifying a period of inactivity by monitoring the audio captured by the first microphone; and responsive to identifying the period of inactivity, transmitting a second command to the listening device, the second command including instructions to cease processing audio captured by the first microphone.

In an implementation of the foregoing method, the listening device comprises at least one of: a remote control device; or a smart home device.

A computer-readable storage medium is described herein. The computer-readable storage medium has program instructions recorded thereon that, when executed by a processor circuit perform operations. The operations comprise: receiving a first signal; detecting a first event based on an analysis of the first signal; determining to enable processing of audio captured by a first microphone of a listening device based at least on the detected first event; and responsive to said determining, transmitting a first command to the listening device, the first command including instructions to enable processing of the audio captured by the first microphone.

In an implementation of the foregoing computer-readable storage medium, the first signal comprises at least one of: a media content signal that is provided to a media presentation device that presents media content based on the media content signal; an audio signal captured by a second microphone that is proximate to the media presentation device; a network signal received by a network interface; or an image or a video of the media presentation device captured by a camera.

In an implementation of the foregoing computer-readable storage medium, said transmitting the first command to the listening device causes the listening device to: provide power to the first microphone to cause the first microphone to capture the audio; and the operations further comprise: receiving the audio captured by the first microphone from the listening device.

In an implementation of the foregoing computer-readable storage medium, said transmitting the first command to the listening device causes the listening device to: provide audio captured by the first microphone to an application executing on a network device for processing thereof.

In an implementation of the foregoing computer-readable storage medium, the operations further comprise: comparing an audio signal captured by the first microphone to an expected audio output of a media presentation device; determining whether a level of similarity between the audio signal and the expected audio output meets a threshold condition; in response to determining that the level of similarity between the audio signal and the expected audio output meets the threshold condition, determining that processing of the audio captured by the first microphone is enabled; and in response to determining that the level of similarity between the audio signal and the expected audio output does not meet the threshold condition, performing a corrective action.

In an implementation of the foregoing computer-readable storage medium, the detected first event comprises one of: an incoming audio or video call; an indication that an audio input feature of an application has been enabled; a determination that an application is in a state to accept user input; or launching of an application with audio input features.

In an implementation of the foregoing computer-readable storage medium, the detected first event comprises the incoming call; and the operations further comprise: receiving, from the listening device, an audio signal captured by the first microphone while the first microphone is on; and determining whether to accept the incoming call based at least on the audio signal.

In an implementation of the foregoing computer-readable storage medium, said determining to enable processing of audio captured by the first microphone based at least on the detected first event comprises: determining a user is present based on at least one of: an analysis of an image or a video of the user captured by a camera; an analysis of an output of a sensor of the listening device; an analysis of data obtained from a smart home application associated with the user; or an analysis of an output of a motion detector; and determining to enable processing of audio captured by the first microphone based at least on the detected first event and the determination that the user is present.

In an implementation of the foregoing computer-readable storage medium, the operations further comprise: detecting a second event; determining to cease processing audio captured by the first microphone based at least on the detected second event; and transmitting a second command to the listening device, the second command including instructions to cease processing audio captured by the first microphone.

In an implementation of the foregoing computer-readable storage medium, the operations further comprise: determining that a caller is speaking; and in response to determining that the caller is speaking, transmitting a second command to the listening device, the second command including instructions to cease processing audio captured by the first microphone.

In an implementation of the foregoing computer-readable storage medium, the operations further comprise: identifying a period of inactivity by monitoring the audio captured by the first microphone; and responsive to identifying the period of inactivity, transmitting a second command to the listening device, the second command including instructions to cease processing audio captured by the first microphone.

In an implementation of the foregoing computer-readable storage medium, the listening device comprises at least one of: a remote control device; or a smart home device.

### II. Example Embodiments

Embodiments are provided for automatic processing state control of a microphone, such as a microphone of a listening device. For instance, a device (e.g., a switching device or other consumer electronic device) may detect an event and determine that the processing of audio captured by a microphone of a listening device (e.g., a smart home device, a remote control device, or another device in a system (e.g., a media system) that includes a microphone) should be enabled based on the detected event. The device transmits a command to the listening device, and the command includes instructions to enable processing of audio captured by the microphone. Example processing states of a microphone include, but are not limited to, a powered on state, a powered off state, a standby state (e.g., the microphone is powered with a power level lower than the power required to cause the microphone to capture audio), a muted state, a state with a particular sensitivity level (e.g., a high sensitivity, a low sensitivity, a moderate sensitivity, a sensitivity on a measurable scale), a state in which the microphone and/or listening device provide captured audio to a particular device or application (i.e., for processing thereof), a state in which the microphone and/or listening device do not provide captured audio to a particular device or application (e.g., processing of captured audio by the particular device or application is not enabled but the microphone is capturing audio for other functions), and/or any other state of a microphone of a listening device as described elsewhere herein, or as would be understood by a person ordinarily skilled in the relevant art(s) having benefit of this disclosure.

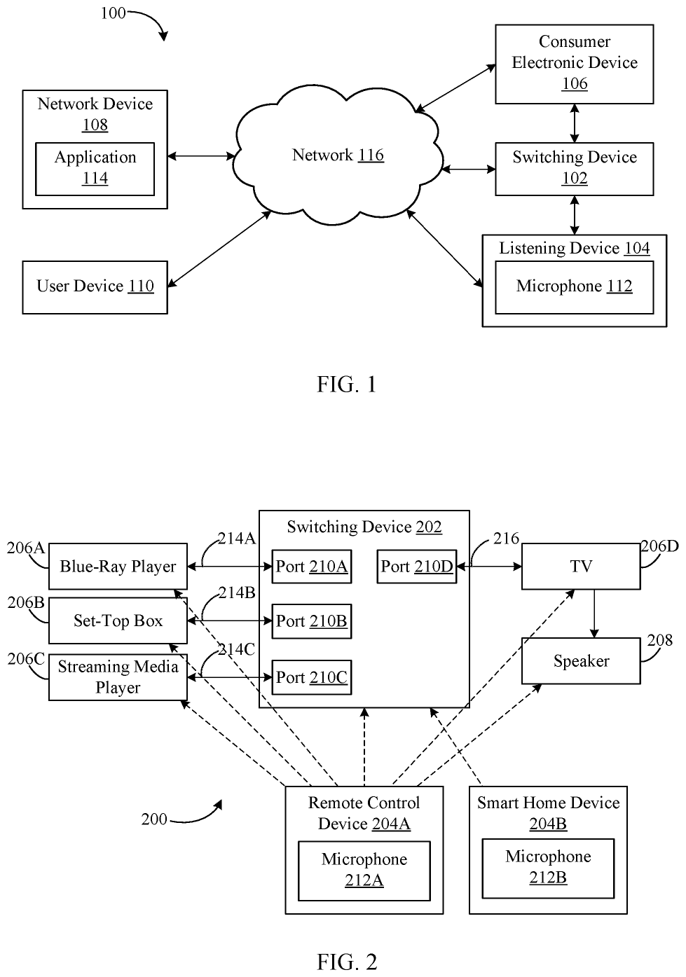

To help illustrate techniques for automatic processing state control of a microphone, FIG. 1 will now be described. FIG. 1 is a block diagram of a system 100 configured to automatically control the processing state of a microphone of a listening device, according to an exemplary embodiment. As shown in FIG. 1, system 100 includes a switching device 102, a listening device 104, a consumer electronic device 106, a networking device 108, and a user device 110. As also shown in FIG. 1, listening device 104 comprises a microphone 112 and network device 108 comprises an application 114 (e.g., executed by a processing circuit of network device 108). Each of switching device 102, listening device 104, consumer electronic device 106, networking device 108, and user device 110 are communicatively coupled via a network 116. Network 108 may comprise one or more networks such as local area networks (LANs), wide area networks (WANs), enterprise networks, the Internet, etc., and may include one or more of wired and/or wireless portions. The features of system 100 are described in detail as follows.

Switching device 102 is configured to select (e.g., switch between) different audio and/or video source devices that are coupled to ports of switching device 102 (not shown in FIG. 1 for brevity). In accordance with an embodiment, switching device 102 is an HDMI-Based switching device, but the embodiments described herein are not so limited.

Listening device 104 is configured to power, manage, control, and/or otherwise support microphone 112. Examples of listening device 104 include, but are not limited to, a remote control device or a smart home device, as described elsewhere herein. In accordance with an embodiment, listening device 104 is operable to control any or all of switching device 102 and/or consumer electronic device 106. In accordance with another embodiment, listening device 104 communicates with application 114 (e.g., over network 116) to provide audio captured by microphone 112, receive instructions from application 114, and/or the like. Listening device 104 may include a display screen and/or one or more physical interface elements (e.g., buttons, sliders, jog shuttles, etc.). In accordance with an embodiment, the display screen (or a portion thereof) may be a capacitive touch display screen. The display screen may be configured to display one or more virtual interface elements (e.g., icons, buttons, search boxes, etc.). The display screen may be configured to enable a user to interact, view, search, and/or select content for viewing via any of switching device 102 and/or consumer electronic device 106.

As noted above and shown in FIG. 1, listening device 104 comprises a microphone 112. Microphone 112 may be configured to capture audio signals. Listening device 104 may be configured to provide captured audio signals to one or more of switching device 102, consumer electronic device 106, application 114, and/or user device 110 to enable processing of the captured audio signals. For instance, listening device 104 may provide audio captured by microphone 112 to switching device 102, consumer electronic device 106, network device 108, and/or user device 110 to enable a user to interact, view, search, and/or select content, and/or perform functions related to audio input features of one or more of switching device 102, consumer electronic device 106, network 108, user device 110, and/or an application executed by switching device 102, consumer electronic device 106, network device 108 (e.g., application 114), and/or user device 110.

Consumer electronic device 106 is a device configured to provide or receive media content signals for playback. For instance, in accordance with an embodiment, consumer electronic device 106 is configured to provide media content signals for playback and is referred to as a “source” device. In accordance with an alternative embodiment, consumer electronic device 106 is configured to receive media content signals and is referred to as a “sink” device. In accordance with another alternative embodiment, consumer electronic device 106 performs functions of both a source and sink device. Media content signals may include audio signals, video signals, or a combination of audio and video signals. Examples of consumer electronic devices include, but are not limited to, televisions (TVs), HDTVs, projectors, speakers, DVD players, Blu-ray players, video game consoles, set-top boxes, streaming media players, etc. Examples of streaming devices include, but are not limited to, Roku™ devices, AppleTV™ devices, Chromecast™ devices, and/or the like.

In accordance with an embodiment, switching device 102, listening device 104, and/or consumer electronic device 106 are part of a media system. The media system may be associated with a user (e.g., an owner, a family user, a household user, an individual user, a service team user, a group of users, etc.). Further examples of media systems are described with respect to FIGS. 2, 3, 11, and 12, as well as elsewhere herein. As shown in FIG. 1, the media system comprises one switching device 102, one listening device 104, and one consumer electronic device 106. Alternatively, a media system may comprise any number of switching devices, listening devices, and consumer electronic devices. For instance, system 100 may comprise a smart home device, switching device 102, a TV, a streaming media player, a Blue-Ray player, and a respective remote control device operable to control each of switching device 102, the TV, the streaming media player, and the Blue-Ray player.

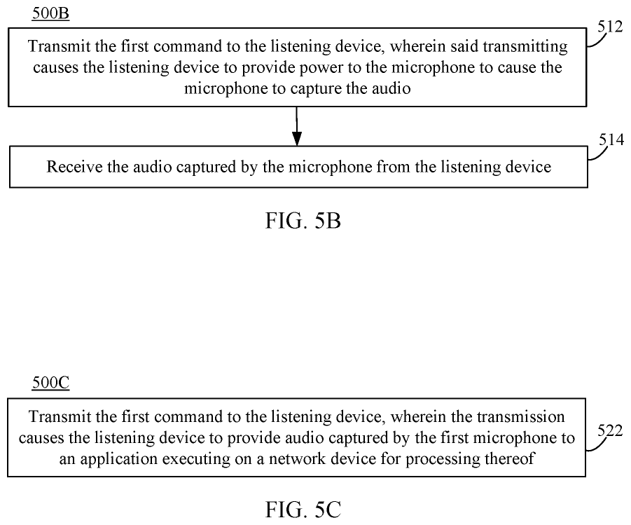

Network device 108 is configured to manage application 114. Network device 108 may be any type of stationary or mobile processing device including, but not limited to, a desktop computer, a server, a mobile or handheld device (e.g., a tablet, a personal data assistant (PDA), a smart phone, a laptop, etc.), an Internet-of-Things (IoT) device, etc. For instance, in accordance with an embodiment, network device 108 is a network-accessible server (e.g., a cloud server), that hosts application 114. Application 114 is an application configured to process audio received by microphone 112 and/or transmit instructions to switching device 102, listening device 104, consumer electronic device 106, and/or user device 110. In accordance with an embodiment, application 114 is associated with an entity that manufactures switching device 102, provides firmware for switching device 102, and/or provides an application executed by switching device 102. For example, application 114 in accordance with an embodiment, is an audio processing application that receives audio captured by microphone 112, processes the audio, and transmits instructions to switching device 102 and/or listening device 104 based on the processed audio. Additional details regarding listening devices providing audio captured by microphones to applications executing on network devices are described with respect to FIG. 5C, as well as elsewhere herein.

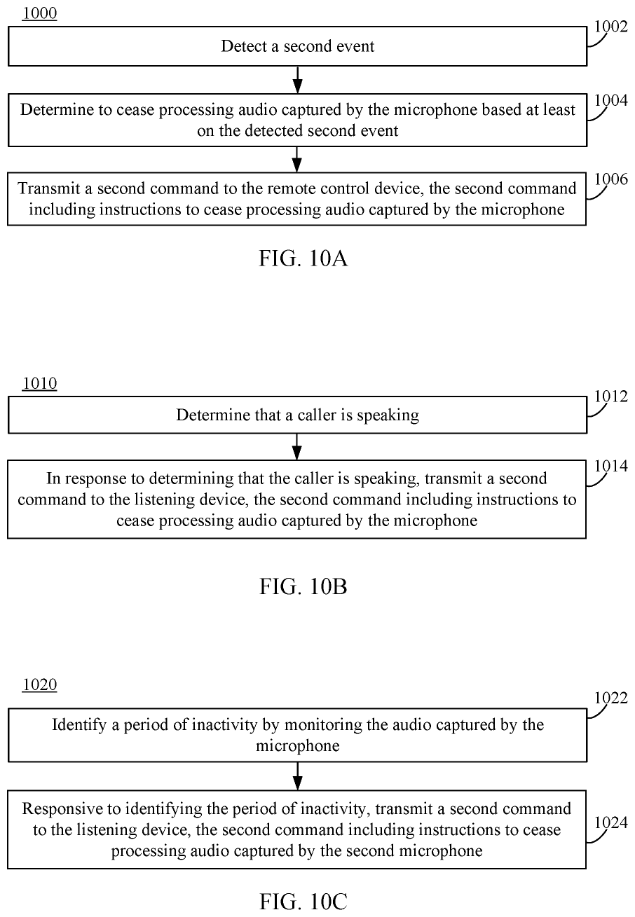

User device 110 is a computing device associated with a user. User device 110 may be any type of stationary or mobile processing device, as described elsewhere herein. In accordance with an embodiment, user device 110 is a consumer electronic device of another media system (e.g., a media system different from the media system comprising switching device 102, listening device 104, and consumer electronic device 106). In this context, user device 110 may be configured to operate in a manner similar to consumer electronic devices described elsewhere herein. In accordance with another embodiment, user device 110 is a switching device of such another media system and operates in a manner similar to switching device 102. In accordance with another embodiment, user device 110 is a listening device that operates in a manner similar to listening device 104. In accordance with an embodiment, a user of user device 110 interacts with an interface of user device 110 to initiate a call to a user of switching device 102 or receive a call from a user of switching device 102. Additional details regarding initiating, accepting, and conducting calls between different devices (such as user device 110 and switching device 102) are described with respect to FIGS. 7 and 10B, as well as elsewhere herein.

To help further illustrate techniques for automatic processing state control of a microphone, FIG. 2 will now be described. FIG. 2 is a block diagram of a media system 200 (“system 200” hereinafter) configured to automatically control the processing state of a microphone of a listening device, according to an exemplary embodiment. As shown in FIG. 2, system 200 includes a switching device 202, a remote control device 204A, a smart home device 204B, a plurality of consumer electronic devices 206A-206D, and one or more speakers 208 (“speakers 208” herein). Switching device 202 is a further example of switching device 102, remote control device 204A and smart home device 204B are further examples of listening device 104, and consumer electronic devices 206A-206D and speakers 208 are further examples of consumer electronic device 106, as respectively described with respect to FIG. 1.

Consumer electronic devices 206A-206C are configured to provide media content signals (e.g., media content signals 214A, 214B, and 214C, respectively) for playback and are referred to as “source” devices. Media content signals may include audio signals, video signals, or a combination of audio and video signals. Consumer electronic device 206D is configured to receive media content signals (e.g., media content signals 216) and is referred to as a media presentation device and/or a “sink” device. Consumer electronic device 206D is coupled to one or more speakers 208. Speakers 208 may be incorporated in consumer electronic device 206D, or alternatively, may be part of an external sound system that is coupled to consumer electronic device 206D and/or switching device 202. In an embodiment in which speakers 208 are part of an external sound system, speakers 208 may be communicatively coupled to consumer electronic device 206D via a wired interface (e.g., an HDMI cable, an optical cable, a universal serial bus (USB) cable, an Ethernet cable, etc.) or a wireless interface (e.g., Bluetooth, Wi-Fi, etc.).

As shown in FIG. 2, consumer electronic device 206A is coupled to a first port 210A of switching device 202, consumer electronic device 206B is coupled to a second port 210B of switching device 202, consumer electronic device 206C is coupled to a third port 210C of switching device 202, and consumer electronic device 202D is coupled to a fourth port 210D of switching device 204. In accordance with an embodiment, ports 210A-210D are HDMI ports; however, embodiments described herein are not so limited. As further shown in FIG. 2, consumer electronic device 206A is a Blu-ray player, consumer electronic device 206B is a set-top box, consumer electronic device 206C is a streaming media player, and consumer electronic device 206D is a TV. The depiction of these particular electronics devices is merely for illustrative purposes. It is noted that while FIG. 2 shows that switching device 202 includes four ports 210A-210D, switching device 202 may include any number of ports, and therefore, may be coupled to any number of consumer electronic devices. As described with respect to FIG. 2, ports 210A-210D are ports for receiving and/or providing media content signals (e.g., AV ports); however, switching device 202 may include other types of ports (not shown in FIG. 2), such as, but not limited to, input/output (IO) ports, network ports, and/or the like.

Switching device 202 is configured to select (e.g., switch between) different audio and/or video source devices that are coupled to ports 210A-210C (e.g., consumer electronic device 206A, consumer electronic device 206B or consumer electronic device 206C) and provide an output signal (e.g., media content signals 216) comprising audio and/or video signals (e.g., media content signals 214A, media content signals 214B or media content signals 214C) provided by the selected media content source device. Media content signals 216 are provided to consumer electronic device 206D that is coupled to port 210D. Media content signals 216 may also be provided to any other device capable of playing back audio and/or video signals (e.g., speaker(s) 208) that may be coupled consumer electronic device 206D and/or to port 210D and/or other port(s) (not shown) of switching device 202.

Remote control device 204A may be operable to control any or all of switching device 202, smart home device 204B, consumer electronic devices 206A-206D, and/or speakers 208. Types of remote control device 204A include, but are not limited to, infrared (IR) remote controllers, Bluetooth controllers, mobile phones, universal remotes, and/or the like. As shown in FIG. 2, system 200 includes one remote control device 204A. Alternatively, multiple remote control devices may be used. For instance, each of switching device 202, smart home device 204B, consumer electronic devices 206A-206D, and/or speakers 208 may be controlled via a respective remote control device.

Smart home device 204B is operable to perform one or more smart home functions with respect to system 200. In accordance with an embodiment, smart home device 204B is operable to control any or all of switching device 202, consumer electronic devices 206A-206D, and/or speakers 208. Types of smart home device 204B include, but are not limited to, smart plugs, smart speakers, smart thermostats, smart appliances, smart TVs, smart device hubs (e.g., smart devices for coordinating and/or controlling other smart home devices), and/or the like. As shown in FIG. 2, system 200 includes one smart home device 204B. Alternatively multiple smart home devices may be used. Furthermore, functions of smart home device 204B may be integrated into one or more of switching device 202 and/or consumer electronic devices 206A-206D. For instance, consumer electronic device 206D may be a smart TV with smart home functions.

As shown in FIG. 2, remote control device 204A includes a microphone 212A and smart home device 204B includes a microphone 212B. Microphone 212A and microphone 212B are each configured to capture audio signals. Remote control device 204A and/or smart home device 204B may be configured to provide respective captured audio signals to one or more of switching device 202, consumer electronic devices 206A-206D, and/or speakers 208 to enable a user to interact, view, search, and/or select content, and/or perform functions related to audio input features of one or more of switching device 202, consumer electronic devices 206A-206D, speakers 208, and/or an application executed by switching device 202, consumer electronic devices 206A-206D, and/or speakers 208. Alternatively, or additionally, remote control device 204A and/or smart home device 204B may be configured to provide respective captured audio signals to an application executing on a network device (e.g., application 114 of FIG. 1) or to a computing device of another user (e.g., user device 110 of FIG. 1).

Switching device 202 may be configured to automatically control the processing state of microphone 212. For example, switching device 202 may detect an event based on one or more of: an analysis of a first media content signal (e.g., media content signals 216) that is provided to a media presentation device (e.g., consumer electronic device 206D), an analysis of an audio signal captured by a microphone that is proximate to the media presentation device (e.g., a built-in microphone of consumer electronic device 206D, a microphone of switching device 202, and/or an external microphone communicatively coupled to switching device 202 via a wired interface (e.g., an HDMI cable, an optical cable, a universal serial bus (USB) cable, an Ethernet cable, etc.) or a wireless interface (e.g., Bluetooth, Wi-Fi, etc.)), an analysis of an image or a video of the media presentation device captured by a camera, and/or another analysis to detect an event. Switching device 202 determines to enable processing of audio captured by microphone 212A and/or microphone 212B based at least on the detected event and transmits a command to the respective listening device (e.g., remote control device 204A and/or smart home device 204B).

### III. Example Embodiments for Controlling Processing State of a Microphone

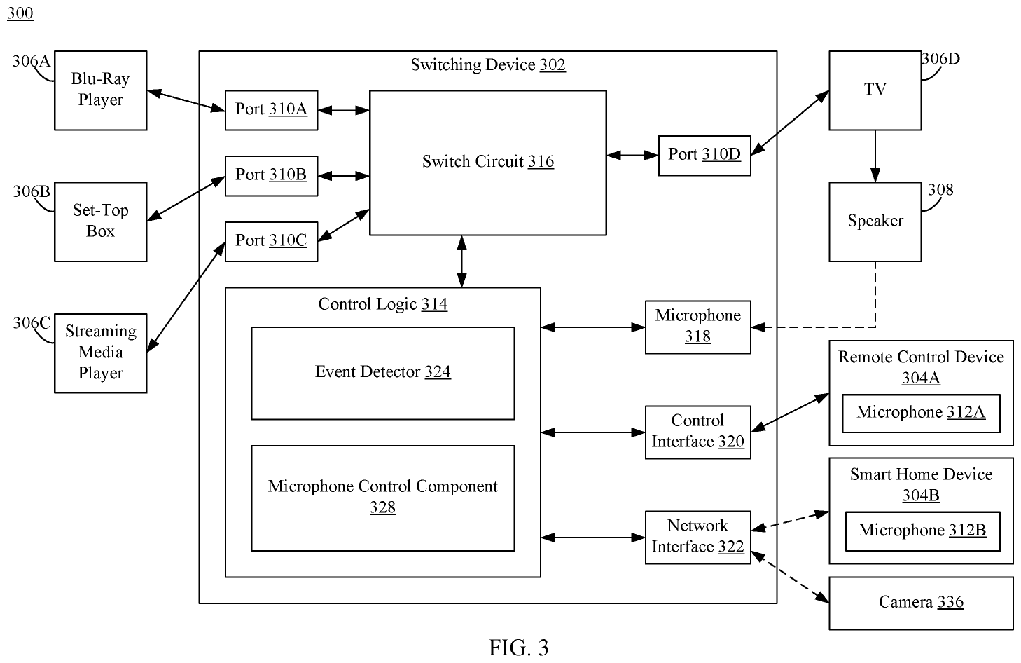

Turning now to FIG. 3, a block diagram of a media system 300 (“system 300” hereinafter) configured to automatically control the processing state of a microphone in a listening device, according to another exemplary embodiment, is shown. System 300 is an example of system 200, as described above with reference to FIG. 2. System 300 includes a switching device 302, a remote control device 304A, a smart home device 304B, consumer electronic devices 306A-306D, a speaker 308, and a camera 336. Consumer electronic devices 306A-306D and speaker 308 may be respective examples of consumer electronic devices 206A-206D and speaker 208, as respectively described with respect to FIG. 2. Any of consumer electronic devices 306A-306D and/or speaker 308 may be any electronic device capable of providing and/or playing back AV signals.

Remote control device 304A is a further example of remote control device 204A as described with respect to FIG. 2. As shown in FIG. 3, remote control device 304A includes a microphone 312A, which may be an example of microphone 212A, as described above in reference to FIG. 2. Remote control device 304A may be a remote control device associated with switching device 302, smart home device 304B, any of consumer electronic devices 306A-306D, speaker 308, or camera 336, a universal remote, a smart phone, and/or any other remote control device, as described elsewhere herein.

Smart home device 304B is a further example of smart home device 204B as described with respect to FIG. 2. As shown in FIG. 3, smart home device 304B includes a microphone 312B, which may be an example of microphone 212B, as described above in reference to FIG. 2.

Switching device 302 may be an example of switching device 202, as described above in reference to FIG. 2. As shown in FIG. 3, switching device 302 includes (e.g., AV) ports 310A-310D, control logic 314, switch circuit 316, microphone 318, control interface 320, and network interface 322. As further shown in FIG. 3, consumer electronic device 306A is coupled to port 310A, consumer electronic device 306B is coupled to port 310B, consumer electronic device 306C is coupled to port 310C, and consumer electronic device 306D is coupled to port 310D. Ports 310A-310C may be automatically configured to be source AV ports, and port 310D may be automatically configured to be a sink AV port. Ports 310A-310D may include one or more HDMI ports, although the embodiments described herein are not so limited.

Switch circuit 316 may be implemented as hardware (e.g., electrical circuits), or hardware that executes one or both of software (e.g., as executed by a processor or processing device) and firmware. Switch circuit 316 is configured to operate and perform functions according to the embodiments described herein. For example, switch circuit 316 is configured to provide switched connections between ports 310A-310C and port 310D. That is, switch circuit 316 may receive input media content signals from source devices (e.g., consumer electronic devices 306A-306C via ports 310A-310C) and provide output media content signals to media presentation devices (e.g., consumer electronic device 306A via port 310D). Switch circuit 316 may comprise one or more switch circuit portions (e.g., comprising one or more switches/switching elements) and may be combined or used in conjunction with other portions of system 300.

Control logic 314 is configured to control switch circuit 316, receive signals from devices coupled to switching device 302 (e.g., from consumer electronic devices 306A-306D (e.g., via switch circuit 316), from speaker 308 (e.g., via switch circuit 316 and/or microphone 318), from remote control device 304A (e.g., via control interface 320 and/or network interface 322), from smart home device 304A (e.g., via network interface 322), from camera 336 (e.g., via network interface 322), from network devices or applications executing thereon over a network (e.g., from application 114 executing on network device 108 over network 116 and via network interface 322)), receive signals from components of switching device 302 (e.g., switch circuit 316, microphone 318, control interface 320, and/or network interface 322), and/or provides signals to devices coupled to switching device 302 and/or to components of switching device 302. As shown in FIG. 3, control logic 314 includes an event detector 324 and a microphone control component 328.

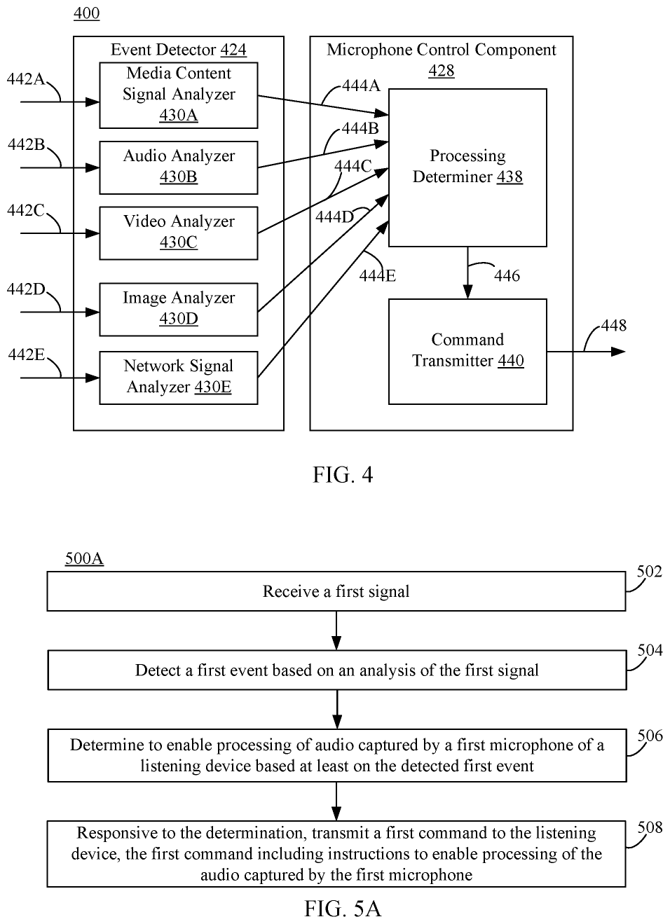

Event detector 324 is configured to detect an event based on an analysis of data (e.g., signals received by control logic 314). Examples of events include, but are not limited to, an incoming audio or video call, an outgoing audio or video call, an audio or video call has ended, an indication that an audio input feature of an application has been enabled or disabled, a determination that an application is in a state to accept user input, the launching of an application with audio input features, the closing of an application with audio input features, the enablement of processing of audio captured by a microphone, the receipt of an instruction from an application (e.g., a network application such as application 114 of FIG. 1, an application executing on a smart home device or consumer electronic device, an application executing on a user computing device (e.g., user computing device 110 of FIG. 1), and/or any other application suitable for transmitting instructions to switching device 302 and/or another device of system 300), and/or the like. Event detector 324 may comprise one or more subcomponents or subservices configured to analyze a particular type of signal. Additional details regarding such subcomponents or subservices are described with respect to FIG. 4, as well as elsewhere herein. Furthermore, additional details regarding detecting events are described with respect to FIGS. 5A and 7-10C, as well as elsewhere herein.

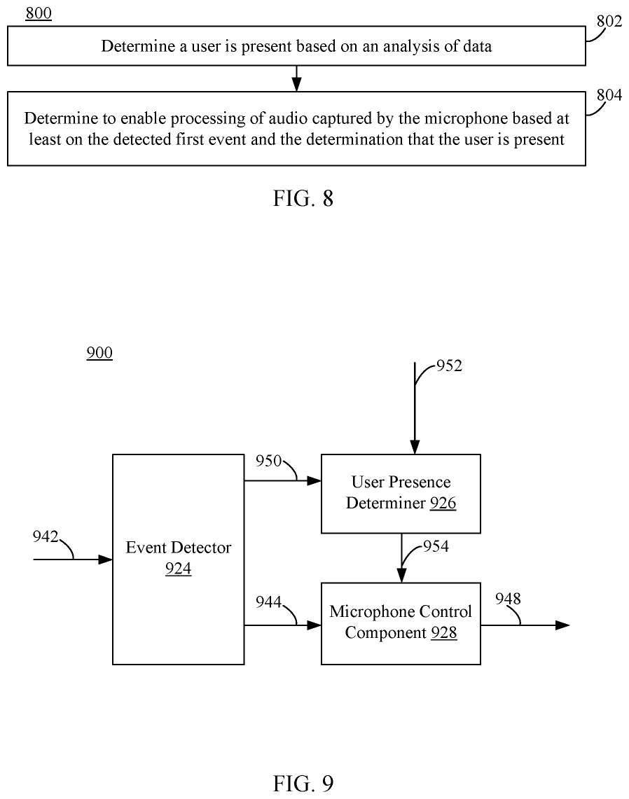

Microphone control component 328 is configured to determine whether or not to enable (or cease) processing of audio captured by a microphone (e.g., microphone 312A and/or microphone 312B). For example, microphone control component 328 may determine whether or not enable (or cease) processing of audio captured by a microphone based on one or more of an event detected by event detector 324, a determination a user is present (as discussed further with respect to FIGS. 8 and 9, and elsewhere herein), a current processing state of the microphone, and/or any other detection, determination, analysis, and/or command described elsewhere herein. If microphone control component 328 determines that a processing state of a microphone of a listening device should be changed, microphone control component 328 transmits (e.g., via control interface 320, via network interface 322, via a port of ports 310A-310D, etc.) a command to the listening device (e.g., remote control device 304A, smart home device 304B, and/or the like) that includes instructions to change the processing state of the microphone (e.g., in a manner that enables or ceases processing of audio captured by the microphone).

For instance, suppose microphone control component 328 determines processing of audio captured by a microphone should be enabled. In this context, microphone control component 328 transmits a command including instructions that, when received by the respective listening device, causes the listening device to provide power to the microphone to cause the microphone to capture audio, change a power state of the microphone (e.g., “off” to “on”, “standby” to “on”, etc.), unmute the microphone, provide audio captured by the microphone to an interface of switching device 302 (e.g., control interface 320, network interface 322, a port of ports 310A-310D, and/or any other interface (not shown in FIG. 3) suitable for receiving audio captured by the respective microphone), provide audio captured by the microphone to an application executing on a network device for processing thereof (e.g., application 114 of FIG. 1), and/or any other function that when performed causes audio captured by the microphone to be processed for operations described herein. Additional details regarding determining whether or not to enable processing of audio captured by a microphone are described with respect to FIGS. 4-6B, 8, and 9, as well as elsewhere herein.

As also described herein, microphone control component 328 may determine that processing of audio captured by a microphone should be ceased. In this context, microphone control component 328 transmits a command including instructions that, when received by the respective listening device, causes the listening device to cease providing power to the microphone that would cause the microphone to capture audio, change a power state of the microphone (e.g., “on” to “off”, “on” to “standby”, etc.), mute the microphone, cease providing audio captured by the microphone to an interface of switching device 302, cease providing audio captured by the microphone to a (e.g., particular) application executing on a (e.g., particular) network device, and/or any other function that when performed causes all or part of processing of audio captured by the microphone to cease. Additional details regarding determining whether or not to turn off microphone 312 are described with respect to FIGS. 10A-10C, as well as elsewhere herein.

In accordance with an embodiment wherein multiple listening devices with corresponding microphones are accessible to switching device 302, microphone control component 328 is configured to determine which listening device to transmit a command to. Microphone control component 328 may determine which listening device to transmit the command to based on a user preference, the type of event detected, a proximity of the listening device to a user, a battery level of one or more listening device(s), a type of communication used to transmit commands and audio between switching device 302 and the listening device, network bandwidth, and/or any other attribute or feature of system 300 and/or its subcomponents suitable for determining to process audio captured by a particular microphone. As a non-limiting example, switching device 302 may determine microphone 312A and/or remote control device 304A is experiencing a technical error (e.g., remote control device 304A is not responsive, a battery level of remote control 304A is below a threshold, and/or the like). In this example, microphone control component 328 transmits a command to smart home device 304B to enable processing of audio captured by microphone 312B.

Control logic 314 may include other components not shown in FIG. 3. For example, control logic 314 in accordance with one or more embodiments includes an identification component, one or more mapping components, and/or an action determination component. An identification component in accordance with an embodiment is configured to identify consumer electronic devices 306A-306D coupled to each of ports 310A-310D, determine identifier(s) thereof (e.g., a type of device (e.g., a DVD player, a Blu-ray player, a video game console, a streaming media device, a TV, an HDTV, a projector, a speaker, etc.), a brand name of the device, a manufacturer of the device, a model number of the device, etc.), and/or provide identifier(s) to one or more mapping components. A mapping component in accordance with an embodiment is configured to determine a device-to-port mapping (e.g., based on identifier(s) received from an identification component). For example, a mapping component may generate a data structure (e.g., a table, a map, an array, etc.) that associates identifier(s) for any given identified device to the port to which that device is coupled (e.g., consumer electronic device 306A is a Blu-ray player coupled to port 310A, consumer electronic device 306B is a set-top box coupled to port 310B, consumer electronic device 306C is a streaming media player coupled to port 310C, and consumer electronic device 306D is a TV coupled to port 310D, as shown in FIG. 3). An action determination component in accordance with an embodiment is configured to perform actions with respect to particular consumer electronic device (e.g., toggle power (i.e., to turn it off or on), issue an operational command (e.g., “play” or “pause”), transmit a notification message, and/or automatically cause switch circuit 316 to connect a first port to which a particular source device (e.g., any of consumer electronic devices 306A-306C) is connected to a second port to which a particular sink device (e.g., consumer electronic device 306D) is connected. In accordance with an embodiment, an action determination component determines actions to be performed based on another mapping component that maps particular actions to one or more particular consumer electronic devices.

Control interface 320 may comprise a receiver configured to receive wireless control signals from a device (e.g., remote control device 304, camera 336, a computing device configured to control switching device 304, consumer electronic device(s) 306A-306D, speaker 308, etc.). Control interface 320 may be configured to receive, detect, and/or sniff wireless control signals from a plurality of different remote control devices (e.g., including remote control device 304), for example, a dedicated remote control device configured to control switching device 302, or dedicated remote control devices each configured to control a respective device of consumer electronic device(s) 306A-306D and/or speakers 308. For instance, control interface 320 may comprise a wireless receiver configured to receive control signals transmitted from a remote control device (e.g., remote control device 304) via an IR-based protocol, an RF-based protocol, and/or an IP-based protocol. Upon detecting control signals, control interface 320 analyzes the control signals to identify one or more identifier(s) therein that uniquely identify the consumer electronic device for which the control signals are intended (e.g., consumer electronic device(s) 306A-306D and/or speaker 308). Control interface 320 may further determine a command (e.g., a toggle power-on/power-off command, play, fast-forward, pause, rewind, etc.) included in the control signals. As will discussed herein, control interface 320 may also be configured to transmit commands from microphone control component 328 to remote control device 304 to turn on or turn off microphone 312. Furthermore, control interface 320 may also be configured to transmit audio signals captured by microphone 312 from remote control device 304 to control logic 314.

Network interface 322 is configured to interface with remote sites or one or more networks and/or devices via wired or wireless connections. Examples of networks include, but are not limited to, local area networks (LANs), wide area networks (WANs), the Internet, etc. In a particular example, and as shown in FIG. 3, camera 336 is coupled to switching device 302 via network interface 322. In another example, user presence determiner 926 accesses data from a smart home application via network interface 322.

Microphone 318 is a microphone that is positioned proximate to a media presentation device (e.g., consumer electronic device 306D and/or speaker 308) such that it can capture audio generated by the media presentation device or a speaker connected thereto. As shown in FIG. 3, microphone 318 may be incorporated as part of switching device 302. In accordance with another embodiment, microphone 318 may be incorporated in a device (e.g., camera 336, one of consumer electronic devices 306A-306D, an external microphone system, etc.) that is external to and communicatively coupled to switching device 302 via either a wired or wireless communication interface, as described herein. Microphone 318 is configured to capture an audio signal (e.g., detect, capture, and/or record audio content played back via speaker 308). The audio signal is provided to audio analyzer 430B, which may detect an event based on the captured audio signal, as described elsewhere herein.

Camera 336 is a camera located proximate to a media presentation device (e.g., consumer electronic device 306D) and/or a user such that it can capture video or images thereof. As shown in FIG. 3, camera 336 may be a camera device external to switching device 302, remote control device 304, and consumer electronic devices 306A-306D. In accordance with another embodiment, camera 336 is incorporated in a device (e.g., switching device 302, remote control device 304, consumer electronic devices 306A-306D, etc.). As shown in FIG. 3, camera 336 sends signals to and/or receives signals from switching device 302 via network interface 322, but the embodiments disclosed herein are not so limited. For instance, camera 336 may be communicatively coupled to a port of switching device 302 (e.g., as a built-in camera of one of consumer electronic devices 306A-306D or a standalone camera coupled to a port not shown in FIG. 3), send signals to and/or receive signals from switching device 302 via control interface 320 (e.g., as a camera of remote control device 304 or a standalone camera). Examples of camera 336 include, but are not limited to, a webcam, a security camera, a built-in camera, and/or the like. Camera 336 is configured to capture and/or record images and/or videos and generate a video signal. The video signal is provided to video analyzer 430C (e.g., for detecting an event based on the generated video signal) and/or user presence determiner 926 (e.g., for determining a user presence), as described elsewhere herein.

As noted above, event detector 324 may be configured to detect an event based on an analysis of a received signal and microphone component 328 may be configured to determine to enable processing of audio captured by a microphone based on the detected event and, responsive to the determination, transmit a command to enable such processing. Event detector 324 and microphone component 328 may be configured to perform these respective operations in various ways, in embodiments. For example, FIG. 4 is a block diagram of a system 400 configured to automatically control the processing state of a microphone of a listening device, according to another exemplary embodiment. As shown in FIG. 4, system 400 comprises an event detector 424 and a microphone control component 428, each of which are further examples of event detector 324 and microphone control component 328, as described with respect to FIG. 3. As further shown in FIG. 4, event detector 424 comprises a media content signal analyzer 430A, an audio analyzer 430B, a video analyzer 430C, an image analyzer 430D, and a network signal analyzer 430E and microphone control component 428 comprises a processing determiner 438 and a command transmitter 440.

To better illustrate embodiments of automatic processing state control of a microphone of a listening device, system 400 is described with respect to FIG. 5A. FIG. 5A is a flowchart 500A of a process for automatic processing state control of a microphone of a listening device, according to an exemplary embodiment. System 400 may operate to perform the steps of flowchart 500A in an embodiment. Not all steps of flowchart 500A need be performed in all embodiments. Other structural and operational embodiments will be apparent to persons skilled in the relevant art(s) based on the following discussion of FIG. 5A with respect to FIG. 4.

Flowchart 500A begins with step 502. In step 502, a first signal is received. For example, event detector 424 of FIG. 4 may receive a media content signal, an audio signal, a video signal, an image signal, and/or a network signal. In some embodiments, event detector 424 receives multiple signals (e.g., sequentially, concurrently, at different times, etc.).

Event detector 424 may comprise one or more subcomponents configured to receive a particular type of signal. For instance, in a first non-limiting example, media content signal analyzer 430A receives a media content signal 442A. Media content signal analyzer 430A may receive media content signal 442A from a source device (e.g., a source device of consumer electronic devices 306A-306C of FIG. 3), intercept media content signal 442A provided to a media presentation device (e.g., consumer electronic device 306D), and/or receive media content signal 442A over a network (e.g., via network interface 322). In a further example, media content signal analyzer 430A accesses media content signal 442A via switch circuit 316.

In a second non-limiting example, audio analyzer 430B receives an audio signal 442B. Audio analyzer 430B may receive audio signal 442B as audio captured by a microphone of a switching device (e.g., microphone 318 of FIG. 3) and/or a microphone of a listening device (e.g., microphone 312A and/or microphone 312B of FIG. 3). In accordance with an alternative embodiment, audio analyzer 430B receives audio portions of media content signals (e.g., media content signals received in a similar manner as described with respect to media content signal analyzer 430A).

In a third non-limiting example, video analyzer 430C receives a video signal 442C. Video analyzer 430C may receive, via a network interface (e.g., network interface 322 of FIG. 3) or port of system 300, video signals generated by a camera (e.g., camera 336 of FIG. 3) and/or captured by a smart home device (e.g., smart home device 304B of FIG. 3). In this context, the captured video may comprise images or videos of consumer electronic devices (e.g., consumer electronic device 106 of FIG. 1, consumer electronic devices 206A-206D and/or speaker 208 of FIG. 2, consumer electronic devices 306A-306D and/or speaker 308 of FIG. 3, and/or the like), users (e.g., users associated with a consumer electronic device, listening device, and/or media system, and/or other users), and/or other subjects that may be captured by a camera and used to detect an event, as described elsewhere herein (e.g., with respect to step 504). In accordance with an alternative embodiment, video analyzer 430C receives video portions of media content signals (e.g., media content signals received in a similar manner as described with respect to media content signal analyzer 430A).

In a fourth non-limiting example, image analyzer 430D receives an image signal 442D. Image analyzer 430D may receive, via an interface (e.g., control interface 320 or network interface 322 of FIG. 3) or a port of system 300, generated by camera 336 (e.g., and received via network interface 322), received from smart home device 304B, and/or received from remote control device 304A. In accordance with an alternative embodiment, image analyzer 430D receives image portions of media content signals (e.g., media content signals received in a similar manner as described with respect to media content signal analyzer 430A). For instance, image analyzer 430D may receive a frame of a video portion of media content signal 442A.

In a fifth non-limiting example, network signal analyzer 430E receives a network signal 442E. Network signal analyzer 430E may receive, via a network interface (e.g., network interface 322 of FIG. 3), network signals (e.g., network data packets) over a network (e.g., network 116 of FIG. 1, a local network of system 400, and/or the like).

In step 504, a first event is detected based on an analysis of the first signal. For example, event detector 424 of FIG. 4 detects a first event based on an analysis of the signal received in step 502. Event detector 424 may detect events in various ways, as described further below with respect to step 504 and respective components of event detector 424 (e.g., media content signal analyzer 430A, audio analyzer 430B, video analyzer 430C, image analyzer 430D, and network signal analyzer 430E), and elsewhere herein.

For instance, with reference to the first non-limiting example described with respect to step 502, media content signal analyzer 430A detects the first event based at least on an analysis of media content signal 442A. In accordance with an embodiment, media content signal analyzer 430A detects an event by identifying content in media content signal 442A that is indicative of the occurrence of an event. For instance, media content signal 442A may include content that media content signal analyzer 430A identifies as being indicative of an incoming audio or video call, an application with audio input features enabled, an application in a state to accept user input, an application with audio input features, and/or the like. In accordance with an embodiment, if media content signal analyzer 430A detects an event, it provides an indication 444A to processing determiner 438v, wherein indication 444A is indicative of the detected event, and flowchart 500A proceeds to step 506.

In accordance with another embodiment and with reference to the second non-limiting example described with respect to step 502, audio analyzer 430B of FIG. 4 detects the first event based at least on an analysis of audio signal 442B. For example, audio analyzer 430B may be configured to perform a cross correlation of audio signal 442B and an audio signature representative of an event. Audio signatures may be stored as audio signature files within a storage of system 400 (not shown in FIG. 4), an external storage device coupled to system 400 (e.g., an external hard drive, a storage of a consumer electronic device, etc.), and/or a network-accessible storage (e.g., cloud storage). Example audio signatures include, but are not limited to, an audio signature representative of an incoming video or audio call tone, an audio signature of an application launch or loading screen, a chime (e.g., indicating audio features are enabled, indicating an application is in a state to accept user input, etc.), and/or any other auditory sound that audio analyzer 430B may analyze to detect an event. In this context, audio analyzer 430B compares audio signal 442B to one or more such audio signatures (e.g., via cross correlation).

Cross correlation can be used to determine whether audio signal 442B and one or more audio signatures are at least substantially similar or not. Ideally, the maximum normalized correlation between two signals will be 1. However, because audio may be captured via microphone (e.g., microphone 312A, microphone 312B, microphone 318, a microphone of another device, etc.), which may be several feet away from a respective speaker (e.g., speaker 308 of FIG. 3) (which is playing the audio), audio signal 442B captured by the microphone is actually equal to the played out audio, plus ambient noise, plus the effect of room reverberations. In this scenario, the maximum correlation will not be 1. Hence, a threshold value (or condition) is estimated through experiment, above which the signatures are assumed to be slightly correlated (i.e., a level of similarity between the audio signal and an audio signature meets the threshold condition). In order to have some room for accepting a noisy environment, the embodiments described herein use a loose threshold (e.g., 0.5). In accordance with an embodiment, this threshold is met more than one time in a continuous stream of audio to make sure that the high number is due to an actual signal rather than noise. In response to determining that the threshold condition has been met (e.g., one or more times), audio analyzer 430B detects the event corresponding to the audio signature file.

In accordance with an embodiment, audio analyzer 430B assigns audio signal 442B a correlation score. For example, audio signal 442B may be scored with respect to an audio signature based on how similar they are. In this context, the assigned correlation score represents a level of similarity between audio signal 442B and the audio signature. Audio analyzer 430B may determine the audio signal matches a particular audio signature if a correlation score meets or exceeds a correlation threshold. If so, audio analyzer 430B detects the event corresponding to the audio signature. For example, suppose speaker 308 is outputting audio representative of an incoming audio or video call (e.g., a ring tone or chime). Microphone 318 may capture an audio signal by capturing and/or recording the output of speaker 308 and provide the captured audio signal to audio analyzer 430B. Audio analyzer 430B cross correlates the captured audio signal with one or more audio signatures, including an audio signature representative of the incoming audio or video call. Based at least on the cross correlation, audio analyzer 430B determines a correlation score representative of a level of similarity between captured audio signal 442B and the audio signature representative of the incoming audio or video call and determines that the correlation score meets or exceeds a correlation threshold. In this example, audio analyzer 430B detects an event associated with the incoming audio or video call.

In accordance with an embodiment, and with continued reference to the second non-limiting example described with respect to step 502, if audio analyzer 430B detects an event, it provides an indication 444B to processing determiner 438, wherein indication 444B is indicative of the detected event, and flowchart 500A proceeds to step 506.

In accordance with another embodiment and with reference to the third non-limiting example described with respect to step 502, video analyzer 430C of FIG. 4 detects the first event based at least on an analysis of video signal 442C. For example, video analyzer 430C in accordance with an embodiment utilizes image recognition to analyze video signal 442C and recognize a particular user interface icon, media image, or other visual content displayed on a media presentation device. In accordance with another embodiment, video analyzer 430C performs cross correlation of video signal 442C and a video signature and/or an image signature representative of an event, in a similar manner as described with respect to audio analyzer 430B. Video and image signatures may be stored as video signature files and image signature files, respectively, within a storage of system 400 (not shown in FIG. 4), an external storage device coupled to system 400, and/or a network-accessible storage. Examples of video signatures include, but are not limited to, a video signature representative of an application displaying an incoming video or audio call, a video signature of an application launching or loading, a video signature of a particular action executed by an application, and/or any other visual representation or combination of visual representation and auditory sound that video analyzer 430C may utilize to detect an event. In this context, video analyzer 430C compares video signal 442C to one or more such video signatures (e.g., via cross correlation). Examples of image signatures include, but are not limited to, an image signature representative of an icon displayed by a consumer electronic device and/or application, an image signature representative of a menu of an application, an image signature representative of a person (e.g., a profile picture of a user, a picture of a family member, etc.), an image signature representative of a consumer electronic device, and/or any other image that video analyzer 430C may utilize (e.g., for image recognition) to detect an event. In this context, video analyzer 430C may compare one or more frames of video signal 442C to one or more such image signatures. In accordance with an embodiment, if video analyzer 430C detects an event, it provides an indication 444C to processing determiner 438, wherein indication 444C is indicative of the detected event, and flowchart 500A proceeds to step 506.

In accordance with another embodiment and with reference to the fourth non-limiting example described with respect to step 502, image analyzer 430D of FIG. 4 detects the first event based at least on an analysis of image signal 442D. For example, image analyzer 430D in accordance with an embodiment utilizes image recognition to analyze image signal 442D and recognize a particular user interface icon, media image, or other visual content displayed on a media presentation device. For instance, image analyzer 430D may analyze image signal 442D with respect to one or more image signatures (e.g., as discussed with respect to video analyzer 430C and elsewhere herein) to detect an event. In accordance with an embodiment, if image analyzer 430D detects an event, it provides an indication 444D to processing determiner 438, wherein indication 444D is indicative of the detected event, and flowchart 500A proceeds to step 506.

In accordance with another embodiment and with reference to the fifth non-limiting example described with respect to step 502, network signal analyzer 430E of FIG. 4 detects the first event based at least on an analysis of network signal 442E. For example, network signature analyzer 430D in accordance with an embodiments analyzes packets received over a network (e.g., as network signal 442E), headers of such packets, identifiers included in the packets (e.g., identifiers of receiving devices, identifiers of transmitting devices, identifiers of associated applications, identifiers of associated users and/or user accounts), the type of network signal, and/or any other information associated with and/or derived from network signal 442E that network signal analyzer 430E may analyze to detect an event. In accordance with an embodiment, if network signal analyzer 430E detects an event, it provides an indication 444E to processing determiner 438, wherein indication 444E is indicative of the detected event, and flowchart 500A proceeds to step 506.

As described with respect to step 504 and several non-limiting examples, media content signal analyzer 430A, audio analyzer 430B, video analyzer 430C, image analyzer 430D, and network signal analyzer 430E are configured to provide respective indications 444A, 444B, 444C, 444D, 444E (collectively “indications 444A-444E”) to processing determiner 438 if a respective event is detected. Each of indications 444A-444E may include event information associated with the detected event, in embodiments. Examples of event information include, but are not limited to, a type of event detected, a timestamp of the detected event (e.g., a time when the component of event detector 424 detected the event, a timestamp of a portion of the analyzed signal associated with the event, etc.), a format of the analyzed signal, a user associated with the signal (e.g., a caller associated with an audio or video call), an originating device or application of the signal (e.g., a source device that provided a media content signal, a network device or application that provided a network signal, a microphone that provided an audio signal, a camera that provided an image or video signal, a user computing device that provided a network signal, and/or any other originating device or application, as would be understood by a person skilled in the relevant art(s) having benefit of this disclosure), and/or any other information associated with and/or indicative of the detected event that may be used by microphone control component 428 (or a component thereof) in performing its respective functions, as described elsewhere herein.

In step 506, the enablement of processing of audio captured by a first microphone of a listening device is determined based at least on the detected first event. For example, processing determiner 438 determines to enable processing of audio captured by microphone 312A and/or microphone 312B of FIG. 3 based at least on the detected event indicated in one or more indications received from event detector 324 (e.g., indication 444A from media content signal analyzer 430A, indication 444B from media content signal analyzer 430B, indication 444C from video analyzer 430C, indication 444D from image analyzer 430D, indication 444E from network signal analyzer 430E, and/or another type of indication received from event detector 424, as described elsewhere herein). In accordance with an embodiment, processing determiner 438 may determine whether or not to enable processing of audio captured by microphone 312A and/or microphone 312B based at least on the detected event and a processing state of the microphone 312. For instance, if processing determiner 438 determines microphone 312A is in an “on” power state and audio captured by microphone 312A is already provided to (or otherwise accessible to) system 400, it may determine not to transmit another command to turn on microphone 312A. As discussed further with respect to FIGS. 8 and 9 (and elsewhere herein), processing determiner 438 may also determine whether or not to turn on microphone 312A and/or microphone 312B based at least on the detected event and a determined user presence. In embodiments, if processing determiner 438 determines to enable processing of audio captured by microphone 312A and/or microphone 312B and transmits a process enable signal 446 to command transmitter 440, and flowchart 500A proceeds to step 508.

In step 508, a first command is transmitted to the listening device responsive to the determination. The first command includes instructions to enable processing of the audio captured by the first microphone. For example, in response to receiving process enable signal 446, command transmitter 440 transmits command 448 to the listening device comprising the microphone (e.g., remote control device 304A comprising microphone 312A, smart home device 304B comprising microphone 312B, and/or the like). Command 448 comprises instructions to enable processing of audio captured by the microphone. For instance, command 448 may include instructions that, when received by the respective listening device, causes the listening device to provide power to the microphone to cause the microphone to capture audio, change a power state of the microphone (e.g., “off” to “on”, “standby” to “on”, etc.), unmute the microphone, provide audio captured by the microphone to an interface of system 400 (e.g., a control interface such as control interface 320 of FIG. 3, a network interface such as network interface 322 of FIG. 3, a port of system 400 (not shown in FIG. 3 for brevity), and/or any other interface suitable for receiving audio captured by the respective microphone), provide audio captured by the microphone to an application executing on a network device for processing thereof (e.g., application 114 of FIG. 1), and/or any other function that when performed causes audio captured by the microphone to be captured. Additional details regarding transmitting a command to a listening device to enable processing of audio captured by a microphone are described with respect to FIGS. 5B and 5C, as well as elsewhere herein.

Thus, system 400 of FIG. 4 has been described with respect to flowchart 500A of FIG. 5A. In an aspect, processing determiner 438 determines to change a processing state of a microphone based on one or more indications received from event detector 424. As shown in FIG. 4, media content signal analyzer 430A, audio analyzer 430B, video analyzer 430C, image analyzer 430D, and network signal analyzer 430E each provide respective indications of indications 444A-444E. In an alternative embodiment, one or more analyzers of event detector 424 are combined as a single analyzing component. For instance, video analyzer 430C and image analyzer 430D may be combined into a video and image analyzer that detects events based on an analysis of image and/or video signals. Furthermore, event detector 424 in accordance with another alternative embodiment may determine whether or not an event is detected based on multiple indications generated by respective analyzers. For instance, event detector 424 may detect an event based on a combination of an indication generated by media content signal analyzer 430A indicating that a video call application interface is being provided to a sink device and an indication generated by audio analyzer 430B indicating that a chime has been detected. In this alternative, event detector 424 may provide each individual indication to processing determiner 438 or provide a single indication indicative of the detected event. By analyzing multiple signals, this alternative embodiment of event detector 424 reduces false flags (e.g., unnecessarily enabling processing of audio captured by a microphone).

Command transmitter 440 of FIG. 4 may be configured to transmit a first command to a listening device to enable processing of the audio captured by a microphone of the listening device in various ways, in embodiments. For example, FIG. 5B is a flowchart 500B of a process for enabling processing of audio captured by a microphone of a listening device, according to an exemplary embodiment. Flowchart 500B is a further example of step 508 of FIG. 5A. Command transmitter 440 may operate to perform the steps of flowchart 500B in an embodiment. Not all steps of flowchart 500B need be performed in all embodiments. Other structural and operational embodiments will be apparent to persons skilled in the relevant art(s) based on the following discussion of FIG. 5B with respect to FIGS. 3 and 4.

Flowchart 500B starts with step 512. In step 512, the first command is transmitted to the listening device. The transmission causes the listening device to provide power to the microphone to cause the microphone to capture the audio. For example, command transmitter 440 transmits command 448 to remote control device 304A (e.g., via control interface 320) and/or smart home device 304B (e.g., via network interface 322) of FIG. 3 to cause the respective listening device to provide power to a respective microphone (e.g., microphone 312A and/or microphone 312B) to cause the microphone to capture audio. In accordance with an embodiment, the microphone is an “off” state and command 448 causes the listening device to power the respective microphone to an “on” state. In accordance with another embodiment, the microphone is in a “standby” or “low power” state and command 448 causes the listening device to power the respective microphone to an “on” state.

In step 504, the audio captured by the microphone is received from the listening device. For example, switching device 302 of FIG. 3 receives audio captured by microphone 312A and/or microphone 312B, as described elsewhere herein.

As noted above, command transmitter 440 of FIG. 4 may be configured to transmit a first command to a listening device to enable processing of the audio captured by a microphone of the listening device in various ways, in embodiments. For example, FIG. 5C is a flowchart 500C of a process for enabling processing of audio captured by a microphone of a listening device, according to another exemplary embodiment. Command transmitter 440 may operate to perform the steps of flowchart 500C in an embodiment. Note flowchart 500C need not be performed in all embodiments. Other structural and operational embodiments will be apparent to persons skilled in the relevant art(s) based on the following discussion of FIG. 5C with respect to FIGS. 1, 3, and 4.

Flowchart 500C comprises step 522. In step 522, the first command is transmitted to the listening device. The transmission causes the listening device to provide audio captured by the first microphone to an application executing on a network device for processing thereof. For example, command transmitter 440 transmits command 448 to remote control device 304A (e.g., via control interface 320) and/or smart home device 304B (e.g., via network interface 322) of FIG. 3 to cause the respective listening device to provide audio captured by a respective microphone (e.g., microphone 312A and/or microphone 312B) to application 114 executing on network device 108. In this context, application 114 is configured to process the audio. In accordance with an embodiment, application 114 processes the audio on behalf of switching device 102. For instance, as an on-limiting example, suppose a user of user device 110 calls a user of switching device 102 utilizing a video call application and application 114 is an instance of the video call application associated with the user of switching device 102. Switching device 102 detects an event and transmits a command to listening device 104 to cause listening device 104 to provide audio captured by microphone 112 to application 114 for processing thereof.

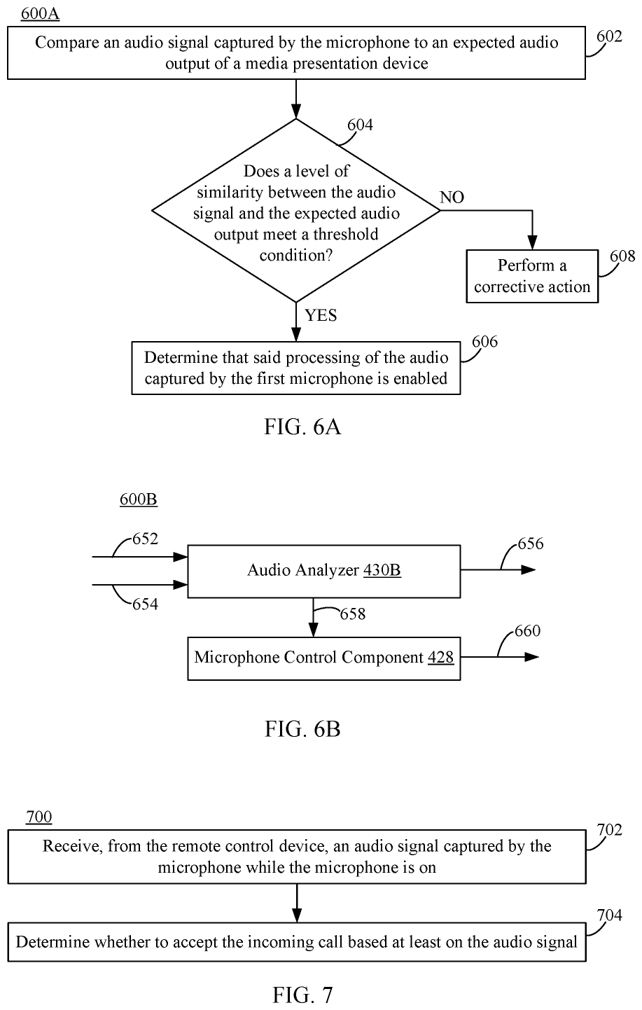

In embodiments, switching device 302 of FIG. 3 may determine the processing state of a microphone in a listening device. For instance, switching device 302 may determine the processing state of a microphone subsequent to transmitting a command to enable processing of audio captured by the microphone (e.g., to confirm the command was received by the listening device, to troubleshoot potential errors (e.g., communication errors, device errors, network errors, and/or the like), etc.). For example, FIG. 6A is a flowchart 600A of a process for determining a processing state of a microphone in a listening device, according to an exemplary embodiment. Switching device 302 may operate to perform the steps of flowchart 600A in an embodiment. For purposes of illustration, flowchart 600A of FIG. 6A is described with respect to FIG. 6B. FIG. 6B shows a block diagram of a system 600B for determining a processing state of a microphone in a listening device, according to an exemplary embodiment. As shown in FIG. 6B, system 600B comprises audio analyzer 430B and microphone control component 428 as described with respect to FIG. 4. Not all steps of flowchart 600A need be performed in all embodiments. Other structural and operational embodiments will be apparent to persons skilled in the relevant art(s) based on the following discussion of FIGS. 6A and 6B.

Flowchart 600A begins with step 602. In step 602, an audio signal captured by the microphone of the listening device is compared to an expected audio output of a media presentation device. For example, audio analyzer 430B of FIG. 6B is configured to compare an audio signal 652 captured by a microphone of a listening device (e.g., microphone 312A of remote control device 304A, microphone 312B of smart home device 304B, and/or the like) to an expected audio output 654 of speaker 308. In accordance with an embodiment, audio analyzer 430B performs a cross correlation between captured audio signal 652 and expected audio output 654. Such cross correlation may be performed in a similar manner to that described above with respect to audio signals captured by microphone 318 and audio signature files. In this context, expected audio output 654 is an audio signature file and audio analyzer 430B determines a level of similarity between the audio signal 652 and expected audio output 654. For example, audio analyzer 430B may generate a correlation score representative of the level of similarity between the two signals. In accordance with an embodiment, audio analyzer 430B accesses expected audio output 654 by accessing media content signals provided to consumer electronic device 306D via switch circuit 316.

In step 604, a determination of whether a level of similarity between the audio signal and the expected audio output meets a threshold condition is made. For example, audio analyzer 430B of FIG. 6B is configured to determine whether a level of similarity between audio signal 652 and expected audio output 654 meets a threshold condition. For instance, in the context of audio analyzer 430B performing a cross correlation between the two signals (as described above with respect to step 602), audio analyzer 430B determines if a corresponding correlation score (i.e., representative of a level of similarity) meets or exceeds a correlation threshold (i.e., meets a threshold condition). If so, flowchart 600A continues to step 606. Otherwise, flowchart 600A continues to step 608.

In step 606, a determination that processing of the audio captured by the first microphone is enabled is made. For example, if the level of similarity determined in steps 602 and 604 above meets the threshold condition, audio analyzer 430B of FIG. 6B determines that the microphone of the listening device is in a state that enables processing of audio captured by the microphone (e.g., the microphone is powered on, a sensitivity of the microphone is at a level that enables the microphone to capture audio output by speakers 308, the microphone is providing captured audio to a device (e.g., switching device 302 of FIG. 3) or application (e.g., application 114 of FIG. 1) for processing thereof). In accordance with an embodiment, audio analyzer 430B provides an indication 656 to a component or application of system 600B or another system described herein (e.g., a component of switching device 302, a consumer electronic device of system 300, a listening device of system 300, a user device over a network (e.g., user device 110 of FIG. 1), an application executing on a network device (e.g., application 114 of FIG. 1), and/or any other component or application described elsewhere herein. Indication 656 is indicative that processing of audio captured by the microphone is enabled.

In step 608, a corrective action is performed. For example, if the level of similarity determined in steps 602 and 604 above does not meet the threshold condition, audio analyzer 430B of FIG. 6B determines that the microphone of the listening device is not in a processing state that enables processing of audio captured by the microphone (e.g., by switching device 302 of FIG. 3, by application 114 of FIG. 1, and/or the like) and performs a corrective action. Example corrective actions include, but are not limited to, providing instructions to microphone control component 428 to reissue a command to a listening device to enable processing of audio captured by a microphone of the listening device, providing instructions to microphone control component 428 to issue a command to a different listening device to enable processing of audio captured by a microphone of the different listening device, report an error to a service team (e.g., via a wireless connection (e.g., via network interface 322), e-mail, text message, etc.), report an error to a user (e.g., via remote control device 304A, smart home device 304B, consumer electronic devices 306A-306D, speaker 308, network interface 322, an e-mail, an app notification, a text message, etc.), and/or sending a command to one or more consumer electronic devices to enter a state (e.g., toggle power (e.g., turn on or off), pause content, play content, decline a call, accept a call, etc.). For instance, as shown in FIG. 6B, audio analyzer 430B transmits instructions 658 to microphone control component 428 to generate a reissued command 660 and transmit reissued command 660 to a listening device (e.g., the same listening device or a different listening device of the associated media system) to cause the listening device to enable processing of audio captured by a microphone of the listening device.

In accordance with an embodiment, audio analyzer 430B or another component of switching device 302 performs and/or requests multiple corrective actions simultaneously or sequentially. As a non-limiting example, suppose audio analyzer 430B determines a level of similarity between audio signal 652 captured by microphone 312A and an audio signature of expected audio output 654 does not meet a threshold condition. In this example, audio analyzer 430B transmits instructions 658 to microphone control component 428 to cause microphone control component 428 to reissue a command (reissue command 660) to remote control device 304A to enable processing of audio captured by microphone 312A. Further suppose, in this example, audio analyzer 430B determines a level of similarity between an audio signal subsequently captured by microphone 312A and an expected audio output (e.g., expected audio output 654 or an updated expected audio output) does not meet a threshold condition. In this scenario, audio analyzer 430B (or another component of system 600B) reports an error to a service team and/or user.

As stated above, an example of a corrective action includes reporting an error to a user (e.g., via remote controller 304A, smart home device 304B, consumer electronic device(s) 306A-306D, speaker 308, network interface 322, an e-mail, an app notification, a text message, etc.). For instance, switching device 302 may report an error to a user indicating that processing of audio captured by microphone 312A was not enabled and/or that audio signals captured by microphone 312 are not processed correctly by audio analyzer 430B (e.g., due to a failure in microphone 312, remote control device 304A, switching device 302 (and/or a component thereof), and/or communication between remote control device 304A and switching device 302. Several non-limiting examples have been described with respect to FIGS. 6A and 6B and remote control device 304A and microphone 312A of FIG. 3; however, similar processes may be performed with respect to audio captured by microphones of smart home devices (e.g., smart home device 304B), of other remote control devices, and/or of other types of listening devices described herein.

### IV. Example Audio-Based Action Embodiments

In accordance with one or more embodiments, switching device 302 of FIG. 3 may automatically determine to perform one or more actions to perform based at least on audio signals captured by the microphone. For example, switching device 302 may automatically determine to perform an action with respect to itself, a component thereof (e.g., ports 310A-310D, control logic 314, switch circuit 316, microphone 318, control interface 320, network interface 322, etc.), a consumer electronic device (e.g., consumer electronic device(s) 306A-306D), a listening device (e.g., remote control device 304A, smart home device 304B, etc.), another device (e.g., speaker 308, camera 336, etc.), particular media content provided by a source device and/or provided to a media presentation device, an application executed by a consumer electronic device, and/or the like. For example, FIG. 7 is a flowchart 700 of a process for determining whether to accept an incoming call, according to an exemplary embodiment. Switching device 302 may operate to perform the steps of flowchart 700 in an embodiment. Not all steps of flowchart 700 need be performed in all embodiments. Other structural and operational embodiments will be apparent to persons skilled in the relevant art(s) based on the following discussion of FIG. 7 with respect to FIG. 3.

Flowchart 700 begins with step 702 and is described with respect to event detector 324 having detected an incoming call (i.e., the event detected in step 504 of flowchart 500A as described with respect to FIG. 5A is an incoming audio or video call). In step 702, an audio signal captured by the microphone while the microphone is on is received from the remote control device. For example, switching device 302 of FIG. 3 receives (e.g., via a port of ports 310A-310D, control interface 320, network interface 322, etc.) an audio signal captured by a microphone of a listening device (e.g., microphone 312A of remote control device 304A, microphone 312B of smart home device 304B, and/or the like) while the microphone is in a processing state that enables processing of audio captured by the microphone.

In step 704, a determination of whether to accept the incoming call is made based at least on the audio signal. For example, control logic 314 (or a component thereof, such as audio analyzer 430B of FIG. 4) analyzes the audio signal received in step 702 to determine whether to accept the incoming call. For instance, audio analyzer 430B may determine the received audio signal is representative of user input indicating either the user intends to accept the incoming call (e.g., a verbal phrase such as, but not limited to, “accept,” “answer,” etc.) or the user intends to decline the incoming call (e.g., a verbal phrase such as, but not limited to, “decline,” “deny,” “hang up,” “send to voicemail,” etc.). In accordance with an embodiment, audio analyzer 430B (or another component of control logic 314 or switching device 302) transmits a command to a source device associated with the incoming call (e.g., via the port the source device is coupled to, via control interface 320, or via network interface 322), transmits a command to an application associated with the incoming call (e.g., via network interface 322), and/or otherwise transmits a command to cause the incoming call to be accepted or declined. In accordance with an embodiment, control logic 314 (or a component thereof) determines which source device is associated with the incoming call based at least on a media content signal provided to consumer electronic device 306D. For instance, control logic 314 (or a component thereof) may analyze an identifier included in or associated with the media content signal to determine which source device (or an application executing on the source device) is associated with the incoming call. In accordance with another embodiment, control logic 314 (or a component thereof) determines which source device is associated with the incoming call based at least on a mapping component of control logic 314 and a switched port of switch circuit 316.

### V. Example Presence Detection Embodiments

In embodiments, switching device 302 of FIG. 3 may determine to transmit commands to enable processing of audio captured by microphones in various ways. For instance, switching device 302 may be configured to transmit a command in response to a determination that a user is present. Switching device 302 may operate to detect a user's presence in various ways, in embodiments. For example, FIG. 8 is a flowchart 800 of a process for automatic processing state control of a microphone of a listening device based on determining a user presence, according to an exemplary embodiment. Switching device 302 may operate to perform the steps of flowchart 800 in an embodiment. For purposes of illustration, flowchart 800 is described with respect to FIG. 9. FIG. 9 is a block diagram of a system 900 for automatic processing state control of a microphone of a listening device based on determining a user presence, according to an exemplary embodiment. As shown in FIG. 9, system 900 comprises an event detector 924 (which is a further embodiment of event detector 324 of FIG. 3), a user presence determiner 926, and a microphone control component 928 (which is a further embodiment of microphone control component 928 of FIG. 3). Not all steps of flowchart 800 need be performed in all embodiments. Other structural and operational embodiments will be apparent to persons skilled in the relevant art(s) based on the following discussion of FIGS. 8 and 9.

User presence determiner 926 is configured to determine whether or not a user is present. For example, user presence determiner 926 may be configured to determine whether or not a user is present based on one or more of, an analysis of an image or a video of the user captured by a camera (e.g., camera 336), an analysis of an output of a sensor of remote control device 304 (e.g., a pressure sensor, a push button, an accelerometer, a gyroscope, a fingerprint sensor, a camera, etc.), analysis of data obtained from a smart home application associated with the user (e.g., user location data obtained from a smart home application, room occupancy data obtained from a smart home application, etc.), an analysis of an output of a motion detector (e.g., of a security system), and/or an analysis of other data indicative of user presence. Additional details regarding determining whether or not a user is present will be described below with respect to FIGS. 8 and 9.

Flowchart 800 begins with step 802. In step 802, a determination that a user is present is made based at least on an analysis of data. For example, user presence determiner 926 of FIG. 9 is configured to analyze data to determine if a user is present. For instance, as shown in FIG. 9 user presence determiner 926 receives signals 950 and/or 952 and analyzes the received signals to determine if a user is present. As shown in FIG. 9, user presence determiner 926 receives signal 950 from event detector 924. In this context, signal 950 may represent a signal 942 received by event detector 924 (e.g., a media content signal, an audio signal, a video signal, an image, a network signal, etc.), an indication generated by event detector 924, and/or a combination of a received signal and a generated indication. As also shown in FIG. 9, user presence determiner 926 receives a signal 952. Examples of 952 include, but are not limited to, signals from a listening device (e.g., remote control device 304A of FIG. 3 (e.g., via control interface 320), smart home device 304B of FIG. 3 (e.g., via network interface 322), etc.), video captured by a camera (e.g., camera 336 of FIG. 3), audio captured by a microphone (e.g., microphone 318 of FIG. 3 and/or the like), an output of an external detection device, service, or system (e.g., a motion sensor, a security system, a smart home security service, etc.). User presence determiner analyzes signals 950 and/or 952 to determine if a user is present.

As a non-limiting example, suppose remote control device 304A includes a sensor (e.g., a pressure sensor, a push button, an accelerometer, a gyroscope, a fingerprint sensor, a camera, etc.) and provides signal 952 to user presence determiner 926 via control interface 320 indicating the output of the sensor. In this context, user presence determiner 926 analyzes signal 952 (i.e., the output of the sensor of remote control device 304A) to determine if a user is present. Alternatively, remote control device 304A analyzes the output of the sensor to determine if a user is present. In this alternative context, remote control device 304A transmits signal 952 to user presence determiner 926, wherein signal 952 indicates if the user is present. User presence determiner analyzes the received indication to determine if the user is present.

In some embodiments, user presence determiner may analyze image or video signals (e.g., captured by camera 336) to determine if a user is present. For example, user presence determiner 926 in accordance with an embodiment utilizes techniques such as facial recognition techniques to recognize a particular user (e.g., a user associated with an application, a user associated with a particular account of an application, a user a caller is intending to call, an owner associated with switching device 302 and/or one or more of consumer electronic devices 306A-306D, a resident of a building switching device 302 is located in (e.g., a resident of a house, a resident of a nursing home, a resident of an apartment, etc.), etc.) present in the analyzed image or video. In accordance with an embodiment, user presence determiner 926 uses techniques to determine if any user or other person is present in the analyzed image or video.

In accordance with another embodiment, user presence determiner 926 of FIG. 9 may analyze data obtained from an application associated with a user, a consumer electronic device (e.g., consumer electronic device(s) 306A-306D), and/or the building switching device 302 is located in to determine if a user is present. For example, user presence determiner 926 may obtain data from a smart home application associated with a user (e.g., via network interface 322 (e.g., from smart home device 304B)). Examples of data user presence determiner 926 may obtain from a smart home application (and/or another suitable application) include, but are not limited to, user location data, room occupancy data, user habit or routine data, and/or any other data that may be analyzed to indicate if a user is present.

In accordance with an embodiment, user presence determiner 926 of FIG. 9 may analyze an output of a motion detector to determine if a user is present. Example motion detectors include, but are not limited to, security system motion sensors, smart home motion sensors (e.g., of smart home device 304B or another smart home device), motion sensors incorporated in a mobile device (e.g., a phone or tablet), and/or any other sensor for detecting motion (e.g., of a user). In accordance with an embodiment, the motion sensor is coupled to a port of switching device 302 (e.g., as a built-in motion sensor of a consumer electronic device 306A-306D or as a standalone motion sensor) and user presence determiner 926 obtains the output of the motion sensor via switch circuit 316. In accordance with another embodiment, the motion sensor is incorporated in camera 336. In accordance with another embodiment, the motion sensor is incorporated in remote control device 304. In accordance with another embodiment, user presence determiner 926 obtains the output of the motion sensor via network interface 322 (e.g., from the motion sensor, from an application associated with the motion sensor, from a security system associated with the motion sensor, and/or the like).

Step 802, as described above, may be performed subsequent to and/or simultaneous to step 504 of flowchart 500A, as described with respect to FIG. 5A. For example, in accordance with an embodiment, event detector 924, microphone control component 928, or another component of system 900 (e.g., another component of control logic 314 of FIG. 3 or switching device 302) may determine that a user's presence is required to enable processing of audio captured by a microphone of a listening device based at least on the event detected in step 504 of FIG. 5A. In this context, step 802 is performed subsequent to step 504 of flowchart 500A. In accordance with another embodiment, user presence determiner 926 performs step 802 simultaneous to, concurrently with, or irrespective to event detector 424 of FIG. 4 performing step 504 of flowchart 500A. For instance, event detector 424 (or a component thereof) may continuously, near continuously, or routinely monitor media content signals, audio signals captured by microphone 318, video signals generated by camera 336, image signals, and/or network signals received via network interface 322 to detect events and user presence determiner 926 may continuously, near continuously, or routinely monitor data to determine if a user is present.

As shown in FIG. 9, if user presence determiner 926 determines a user is present, user presence determiner 926 provides a presence indication 954 to microphone control component 928, wherein presence indication 954 is indicative of the user's presence, and flowchart 800 proceeds to step 804.

Step 804 is a further embodiment of step 506, as described above with respect to flowchart 500A of FIG. 5A. In step 804, a determination to enable processing of audio captured by the microphone of the listening device is made based at least on the detected first event and the determination that the user is present. For example, microphone control component 928 of FIG. 4 determines whether or not to enable processing of audio captured by a microphone of a listening device based at least on the event detected by event detector 924 (as indicated in an indication 944, which is a further example of indications 444A-444E as described above with respect to FIG. 4) and presence indication 954 received from user presence determiner 926.

### VI. Example Embodiments for Ceasing Processing of Captured Audio

Several example embodiments have been described herein with respect to determining whether or not to enable processing of audio captured by a microphone of a listening device. Microphone control component 328 of FIG. 3 may also be configured to determine to cease processing of audio captured by a microphone. For example, FIG. 10A is a flowchart 1000 of a process for turning off a microphone, according to an exemplary embodiment. Switching device 302 may operate to perform the steps of flowchart 1000 in an embodiment. Not all steps of flowchart 1000 need be performed in all embodiments. Other structural and operational embodiments will be apparent to persons skilled in the relevant art(s) based on the following discussion of FIG. 10A with respect to FIG. 3.

Flowchart 1000 begins with step 1002. In step 1002, a second event is detected. For example, event detector 324 of FIG. 3 is configured to detect a second event after processing of audio captured by a microphone of a listening device (e.g., microphone 312A, microphone 312B, and/or the like) has already been enabled (e.g., as described with respect to FIG. 5A and elsewhere herein). For instance, event detector 324 (or a component thereof) may detect that an audio input feature of an application has been disabled, detect that one or more (e.g., all) applications with audio input features have been closed, a video or audio call has ended, and/or the like. Event detector 324 (or a component thereof) may detect such events using any techniques described elsewhere herein. In accordance with an embodiment, event detector 324 transmits an indication of the detected second event to microphone control component 328.

In step 1004, a determination to cease processing of audio captured by the microphone is made based at least on the detected second event. For example, microphone control component 328 determines whether to cease processing of audio captured by the microphone based at least on the second event detected in step 1002. For instance, microphone control component 328 in accordance with an embodiment determines to cease processing of audio to reduce echo (e.g., if a caller is speaking, as discussed further with respect to FIG. 10B and elsewhere herein), to conserve power of the listening device, to improve privacy (e.g., by preventing processing of audio when a user is not utilizing the microphone).

In step 1006, a second command is transmitted to the remote control device. The second command includes instructions to cease processing of audio captured by the microphone. For example, microphone control component 328 transmits a command to a listening device (e.g., to remote control device 304A (e.g., via control interface 320), to smart home device 304B (e.g., via network interface 322), and/or the like) that includes instructions to cease processing of audio captured by the microphone device. In accordance with an embodiment, the instructions cause the listening device to disable processing of audio captured by the microphone on behalf of switching device 302 (e.g., by providing captured audio to switching device (e.g., as described with respect to FIG. 5B) or by providing captured audio to an application executing on a network device (e.g., as described with respect to FIG. 5C)) and (e.g., optionally) maintain processing of audio captured by the microphone for other functions (e.g., functions of remote control device 304A, functions of smart home device 304B). Microphone control component 328 may transmit the second command in a similar manner described with respect to the first command transmitted in step 508 of FIG. 5A, and elsewhere herein.

As discussed with respect to FIG. 10A, microphone control component 328 of FIG. 3 may determine to cease processing of audio captured by a microphone in various ways, in embodiments. For example, FIG. 10B is a flowchart 1010 of a process for ceasing processing of audio a microphone, according to another exemplary embodiment. Flowchart 1010 is a further example of flowchart 1000 of FIG. 10A. Switching device 302 may operate to perform the steps of flowchart 1010 in an embodiment. Not all steps of flowchart 1010 need be performed in all embodiments. Other structural and operational embodiments will be apparent to persons skilled in the relevant art(s) based on the following discussion of FIG. 10B with respect to FIG. 3.

Flowchart 1010 begins with step 1012, which is a further example of step 1002 of flowchart 1000 of FIG. 10A. In step 1012 a determination that a caller is speaking is made. For instance, event detector 324 of FIG. 3 determines that a caller is speaking. Event detector 324 may analyze media content signals, audio signals, video signals, images, network signals, and/or the like to determine a caller is speaking. In this context, the caller speaking is the “second event” detected with respect to FIG. 10A. As a non-limiting example, media content signal analyzer 430A of FIG. 4 analyzes a media content signal provided to consumer electronic device 306D and determines if a caller is speaking. In another example, audio analyzer 430B of FIG. 4 analyzes audio captured by a microphone of the listening device (e.g., utilizing voice recognition to determine a user other than the user being called is speaking) to determine a caller is speaking. In accordance with an embodiment, network signal analyzer 430E analyzes a network signal (e.g., a signal received from the caller's calling device or application) to determine whether the caller is speaking. In embodiments, event detector 324 may provide an indication (e.g., to microphone control component 328) that the caller is speaking.

Flowchart 1010 continues to step 1014, which is a further example of steps 1004 and/or 1006 of flowchart 1000 of FIG. 10A. In step 1014, in response to determining that the caller is speaking, a second command is transmitted to the remote control device. The second command includes instructions to cease processing audio captured by the microphone. For example, microphone control component 328 of FIG. 3 receives an indication that the caller is speaking from event detector 324, determines processing of audio captured by the microphone should be ceased, and transmits a command to the listening device, the command including instructions to cease processing audio captured by the microphone. For instance, suppose the caller is a presenter (e.g., in a conference call, a lecture call, a presentation call, etc.). In this context, control logic 314 and components thereof selectively transmit commands to listening devices (e.g., remote control device 304A, smart home device 304B, and/or the like) to cease processing of audio captured by respective microphone(s) when the presenter is speaking. In accordance with an embodiment, microphone control component 328 transmits a follow-up command to the listening device that includes instructions to re-enable processing of audio captured by respective microphone(s) (e.g., when the presenter is no longer speaking, after a predetermined time, after a user input by a user associated with switching device 302, and/or the like).

As discussed with respect to flowchart 1000 of FIG. 10A, microphone control component 328 of FIG. 3 may determine to cease processing audio captured by a microphone of a listening device in various ways, in embodiments. FIG. 10C is a flowchart 1020 of a process for ceasing processing of audio captured by a microphone, according to another exemplary embodiment. Flowchart 1020 is a further example of flowchart 1000 of FIG. 10A. Switching device 302 may operate to perform the steps of flowchart 1020 in an embodiment. Not all steps of flowchart 1020 need be performed in all embodiments. Other structural and operational embodiments will be apparent to persons skilled in the relevant art(s) based on the following discussion of FIG. 10C with respect to FIG. 3.

Flowchart 1020 begins with step 1022, which is a further example of step 1002 of flowchart 1000 of FIG. 10A. In step 1022, a period of inactivity is identified by monitoring audio captured by the microphone. For example, event detector 324 of FIG. 4 (e.g., via audio analyzer 430B of FIG. 4) may be configured to monitor audio signals captured by a microphone of a listening device (e.g., microphone 312A, microphone 312B, and/or the like). In accordance with an embodiment, event detector 324 may identify a period of inactivity based on the monitored audio. In accordance with an embodiment, a period of inactivity may be identified based on one or more of, a period of time wherein an audio signal associated with an event is not detected, a period of time wherein an audio signal representative of user input is not detected, a period of time wherein an audio signal associated with media content signals provided to consumer electronic device 306D is not detected, a period of time wherein an audio signal corresponding to an expected output of speaker 308 is not detected, and/or the like. In accordance with an embodiment, event detector 324 may provide an indication of the period of inactivity to microphone control component 328. In accordance with another embodiment, microphone control component 328 includes a time out function that identifies the period of inactivity if event detector 324 does not provide an indication of activity after a predetermined time (or, alternatively, if event detector 324 does not cease providing an indication of inactivity).

Flowchart 1020 continues to step 1024, which is a further example of steps 1004 and/or 1006 of flowchart 1000 of FIG. 10A. In step 1024, responsive to identifying the period of inactivity, a second command is transmitted to the listening device, the second command includes instructions to cease processing of audio captured by the second microphone. For example, microphone control component 328 of FIG. 3, responsive to the period of inactivity identified in step 1022, transmits a command to a listening device, the command including instructions to cease processing of audio captured by the microphone of the listening device.

### VII. Further Example Media System Embodiments

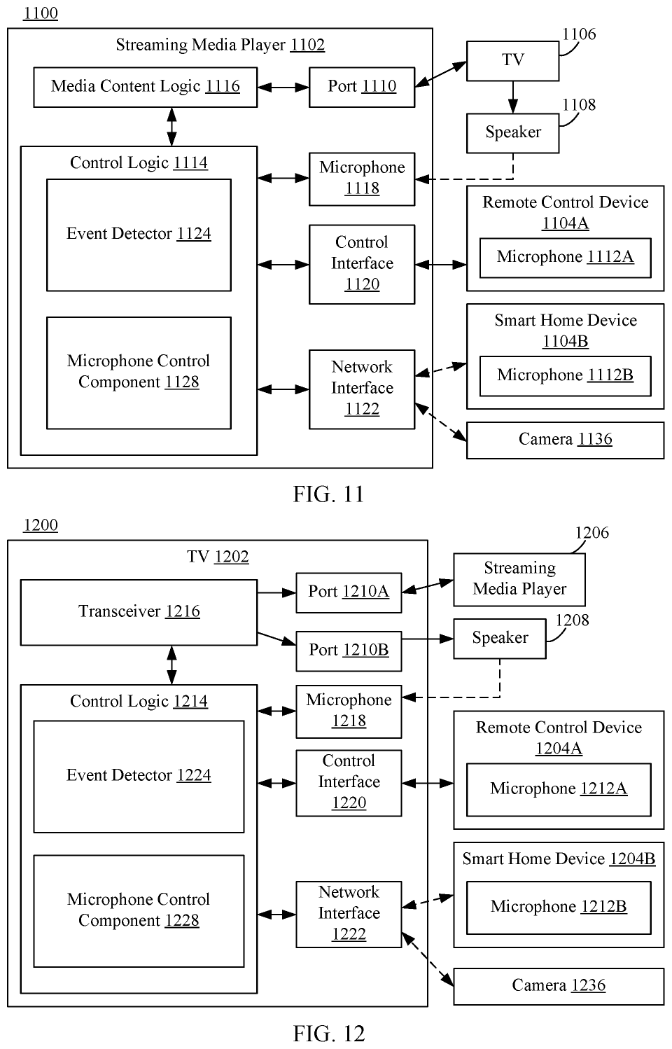

Exemplary embodiments have been described above with respect to a switching device (e.g., switching device 302 of FIG. 3) that is configured to automatically control the processing state of a microphone in a listening device. However, one or more embodiments described herein may be incorporated in any other device, or as a stand-alone device, configured to automatically control the processing state of a microphone in a listening device. For instance, a source device in accordance with an embodiment may be configured to automatically control the processing state of a microphone in a listening device. For example, FIG. 11 is a block diagram of a media system 1100 (“system 1100” hereinafter) configured to automatically control the processing state of a microphone in a listening device, according to another exemplary embodiment. System 1100 is an example of system 200, as described above with reference to FIG. 2. System 1100 includes a streaming media player 1102, a remote control device 1104A, a smart home device 1104B, a consumer electronic device 1106, a speaker 1108, and a camera 1136. Remote control device 1104A is an example of remote control device 304A, as described above with reference to FIG. 3, and includes a microphone 1112A, which is an example of microphone 312A. Smart home device 1104B is an example of smart home device 304B, as described above with reference to FIG. 3, and includes a microphone 1112B, which is an example of microphone 312B. Consumer electronic device 1106, speaker 1108, and camera 1136 are examples of consumer electronic device 306D, speaker 308, and camera 336 of FIG. 3, respectively. In accordance with an embodiment, system 1100 may include a switching device (such as switching device 302 of FIG. 3) coupled between streaming media player 1102 and consumer electronic device 1106, not shown in FIG. 11. In accordance with another embodiment, such switching device is incorporated in streaming media player 1102.

As shown in FIG. 11, streaming media player 1102 includes control logic 1114, media content logic 1116, port 1110, microphone 1118, control interface 1120, and network interface 1122. Control logic 1114, microphone 1118, control interface 1120, and network interface 1122 operate in similar respective manners as control logic 314, microphone 318, control interface 320, and network interface 322, as described above with respect to FIG. 3. While a single port 1110 is shown in FIG. 11, embodiments of streaming media player 1102 may include any number of ports, as described herein.

Media content logic 1116 is configured to provide media content signals to consumer electronic device 1106 via port 1110. For example, a user (e.g., via remote control device 1104A) may interact, view, search, and/or select content for media content logic 1116 to provide to consumer electronic device 1106. In embodiments, media content logic 1116 may access media content over a network via network interface 1122 to provide the media content signals.

As described above, control logic 1114 operates in a similar manner as control logic 314 of FIG. 3. Furthermore, control logic 1114 controls media content logic 1116 (e.g., based on input received via remote control device 1104A, based on input received via smart home device 1104A, via network interface 1122, via microphone 1118, and/or according to actions determined by control logic 1114 or a component thereof). As shown in FIG. 11, control logic 1114 includes an event detector 1124 and a microphone control component 1128, which may each operate in similar respective manners as event detector 324 and microphone control component 328, as described above with respect to FIG. 3. In accordance with an embodiment, control logic 1114 also includes a user presence determiner (not shown in FIG. 11 for brevity) that operates in a similar manner as user presence determiner 926 of FIG. 9. Event detector 1124 may include components for analyzing media content signals, audio signals, video signals, images, and/or network signals to detect events, such as components similar to media content signal analyzer 430A, audio analyzer 430B, video analyzer 430C, image analyzer 430D, and/or network signal analyzer 430E, each respectively described with respect to FIG. 4.

As described above, one or more embodiments may be incorporated in a device other than a switching device configured to automatically control the processing state of a microphone in a listening device. For instance, a media presentation device in accordance with an embodiment may be configured to automatically control the processing state of a microphone in a listening device. For example, FIG. 12 is a block diagram of a media system 1200 (“system 1200” hereinafter) configured to automatically control the processing state of a microphone in a listening device, according to another exemplary embodiment. System 1200 is an example of system 200 as described above with reference to FIG. 2. System 1200 includes a TV 1202, a remote control device 1204A, a smart home device 1204B, a consumer electronic device 1206, a speaker 1208, and a camera 1236. Remote control device 1204A is an example of remote control device 304A, as described above with reference to FIG. 3, and includes a microphone 1212A, which is an example of microphone 312A. Smart home device 1204B is an example of smart home device 304B, as described above with respect to FIG. 3, and includes a microphone 1212B, which is an example of microphone 312B. Consumer electronic device 1206, speaker 1208, and camera 1236 are examples of consumer electronic device 306C, speaker 308, and camera 336 of FIG. 3, respectively. In accordance with an embodiment, system 1200 may include a switching device (such as switching device 302 of FIG. 3) coupled between TV 1202 and consumer electronic device 1206, not shown in FIG. 3. In accordance with another embodiment, such switching device is incorporated in TV 1202.

As shown in FIG. 12, TV 1202 includes ports 1210A and 1210B, control logic 1214, transceiver 1216, microphone 1218, control interface 1220, and network interface 1222. Control logic 1214, microphone 1218, control interface 1220, and network interface 1222 operate in similar respective manners as control logic 314, microphone 318, control interface 320, and network interface 322, as described above with respect to FIG. 3. While two ports 1210A and 1210B are shown in FIG. 12, embodiments of TV 1202 may include a single port or more than two ports, as described herein.

Transceiver 1216 is configured to receive media content signals from consumer electronic device 1206 via port 1210A for display on a screen of TV 1202 (not shown in FIG. 12). Furthermore, transceiver 1216 is configured to provide audio signals of received media content signals to speaker 1208 via port 1210B. In embodiments, transceiver 1216 may also be configured to send commands to consumer electronic device 1206 from control logic 1214 via port 1210A.

As described above, control logic 1214 operates in a similar manner as control logic 314 of FIG. 3. Furthermore, control logic 1214 may access signals (e.g., media content signals) received by or provided by transceiver 1216 (e.g., for analysis by event detector 1224 and/or another component of control logic 1214 or subcomponent thereof), transmit commands to consumer electronic device 1206 and/or speaker 1208 via transceiver 1216, and/or the like. As shown in FIG. 12, control logic 1214 includes an event detector 1224, and a microphone control component 1228, which may each operate in similar respective manners as event detector 324 and microphone control component 328, as described above with respect to FIG. 3. In accordance with an embodiment, control logic 1214 also includes a user presence determiner (not shown in FIG. 12 for brevity) which operates in a manner similar to user presence determiner 926 of FIG. 9. Event detector 1224 may include components for analyzing media content signals, audio signals, video signals, images, and/or network signals to detect events, such as components similar to media content signal analyzer 430A, audio analyzer 430B, video analyzer 430C, image analyzer 430D, and/or network signal analyzer 430E, each respectively described with respect to FIG. 4.

### VIII. Further Example Embodiments and Advantages

A device, as defined herein, is a machine or manufacture as defined by 35 U.S.C. § 101. Devices may be digital, analog or a combination thereof. Devices may include integrated circuits (ICs), one or more processors (e.g., central processing units (CPUs), microprocessors, digital signal processors (DSPs), etc.) and/or may be implemented with any semiconductor technology, including one or more of a Bipolar Junction Transistor (BJT), a heterojunction bipolar transistor (HBT), a metal oxide field effect transistor (MOSFET) device, a metal semiconductor field effect transistor (MESFET) or other transconductor or transistor technology device. Such devices may use the same or alternative configurations other than the configuration illustrated in embodiments presented herein.

Techniques and embodiments, including methods, described herein may be implemented in hardware (digital and/or analog) or a combination of hardware and software and/or firmware. Techniques described herein may be implemented in one or more components. Embodiments may comprise computer program products comprising logic (e.g., in the form of program code or instructions as well as firmware) stored on any computer useable storage medium, which may be integrated in or separate from other components. Such program code, when executed in one or more processors, causes a device to operate as described herein. Devices in which embodiments may be implemented may include storage, such as storage drives, memory devices, and further types of computer-readable media. Examples of such computer-readable storage media include, but are not limited to, a hard disk, a removable magnetic disk, a removable optical disk, flash memory cards, digital video disks, random access memories (RAMs), read only memories (ROM), and the like. In greater detail, examples of such computer-readable storage media include, but are not limited to, a hard disk associated with a hard disk drive, a removable magnetic disk, a removable optical disk (e.g., CDROMs, DVDs, etc.), zip disks, tapes, magnetic storage devices, MEMS (micro-electromechanical systems) storage, nanotechnology-based storage devices, as well as other media such as flash memory cards, digital video discs, RAM devices, ROM devices, and the like. Such computer-readable storage media may, for example, store computer program logic, e.g., program modules, comprising computer executable instructions that, when executed, provide and/or maintain one or more aspects of functionality described herein with reference to the figures, as well as any and all components, steps, and functions therein and/or further embodiments described herein.

Computer readable storage media are distinguished from and non-overlapping with communication media (do not include communication media or modulated data signals). Communication media embodies computer-readable instructions, data structures, program modules or other data in a modulated data signal such as a carrier wave. The term “modulated data signal” means a signal that has one or more of its characteristics set or changed in such a manner as to encode information in the signal. By way of example, and not limitation, communication media includes wired media as well as wireless media such as acoustic, RF, infrared and other wireless media. Example embodiments are also directed to such communication media.

The content recommendation embodiments and/or any further systems, sub-systems, and/or components disclosed herein may be implemented in hardware (e.g., hardware logic/electrical circuitry), or any combination of hardware with software (computer program code configured to be executed in one or more processors or processing devices) and/or firmware.

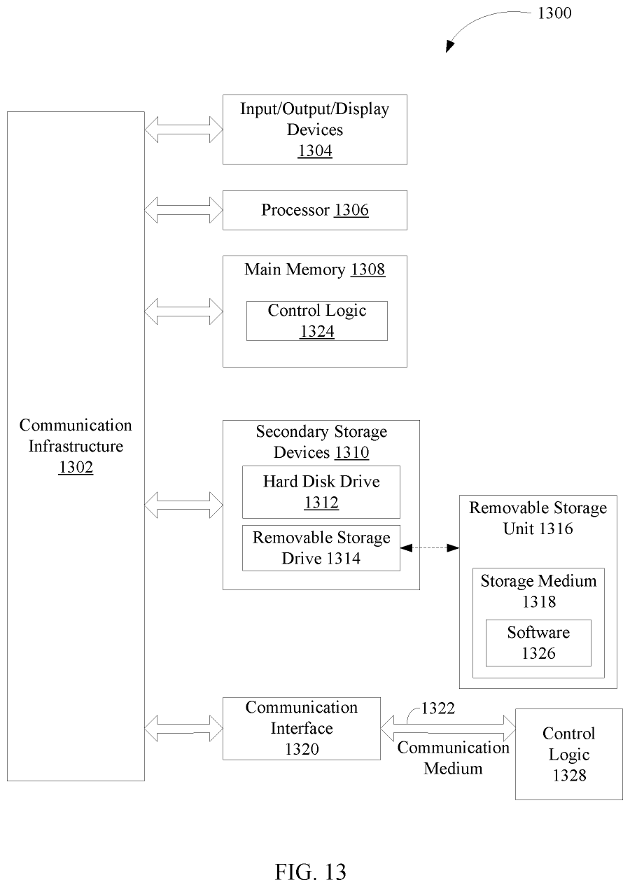

The embodiments described herein, including systems, methods/processes, and/or apparatuses, may be implemented using well known processing devices, servers, electronic devices (e.g., consumer electronic devices) and/or, computers, such as a computer 1300 shown in FIG. 13. It should be noted that computer 1300 may represent communication devices, processing devices, servers, and/or traditional computers in one or more embodiments. For example, switching device 102, listening device 104, consumer electronic device 106, network device 108, user device 110, and/or microphone 112 as described with respect to FIG. 1, switching device 202, remote control device 204A, smart home device 204B, one or more of consumer electronic device(s) 206A-206D, speaker 208, microphone 212A, and/or microphone 222B as described above in reference to FIG. 2, switching device 302 (and/or the components thereof), remote control device 304A (and/or the components thereof), smart home device 304B (and/or the components thereof), one or more of consumer electronic device(s) 306-306D, speaker 308, and/or camera 336 as described above in reference to FIG. 3, system 400 (and/or the components thereof) as described with respect to FIG. 4, system 600B (and/or the components thereof) as described with respect to FIG. 6B, system 900 (and/or the components thereof) as described with respect to FIG. 9, streaming media player 1102 (and/or the components thereof), remote control device 1104A (and/or the components thereof), smart home device 1104B (and/or the components thereof), consumer electronic device 1106, speaker 1108, and/or camera 1136 as described above in reference to FIG. 11, TV 1202 (and/or the components thereof), remote control device 1204A (and/or the components thereof), smart home device 1204B (and/or the components thereof), consumer electronic device 1206, speaker 1208, and/or camera 1236 as described above in reference to FIG. 12, and/or flowcharts 500A, 500B, 500C, 600A, 700, 800, 1000, 1010, and/or 1020 may be implemented using one or more computers 1300.

Computer 1300 can be any commercially available and well-known communication device, processing device, and/or computer capable of performing the functions described herein, such as devices/computers available from International Business Machines®, Apple®, Sun®, HP®, Dell®, Cray®, Samsung®, Nokia®, etc. Computer 1300 may be any type of computer, including a desktop computer, a server, etc.

Computer 1300 includes one or more processors (also called central processing units, or CPUs), such as a processor 1306. Processor 1306 is connected to a communication infrastructure 1302, such as a communication bus. In some embodiments, processor 1306 can simultaneously operate multiple computing threads.

Computer 1300 also includes a primary or main memory 1308, such as random access memory (RAM). Main memory 1308 has stored therein control logic 1324 (computer software), and data.

Computer 1300 also includes one or more secondary storage devices 1310. Secondary storage devices 1310 include, for example, a hard disk drive 1312 and/or a removable storage device or drive 1314, as well as other types of storage devices, such as memory cards and memory sticks. For instance, computer 1300 may include an industry standard interface, such a universal serial bus (USB) interface for interfacing with devices such as a memory stick. Removable storage drive 1314 represents a floppy disk drive, a magnetic tape drive, a compact disk drive, an optical storage device, tape backup, etc.

Removable storage drive 1314 interacts with a removable storage unit 1316. Removable storage unit 1316 includes a computer useable or readable storage medium 1318 having stored therein computer software 1326 (control logic) and/or data. Removable storage unit 1316 represents a floppy disk, magnetic tape, compact disk, DVD, optical storage disk, or any other computer data storage device. Removable storage drive 1314 reads from and/or writes to removable storage unit 1316 in a well-known manner.

Computer 1300 also includes input/output/display devices 1304, such as touchscreens, LED and LCD displays, monitors, keyboards, pointing devices, etc.

Computer 1300 further includes a communication or network interface 1320. Communication interface 1320 enables computer 1300 to communicate with remote devices. For example, communication interface 1320 allows computer 1300 to communicate over communication networks or mediums 1322 (representing a form of a computer useable or readable medium), such as LANs, WANs, the Internet, etc. Network interface 1320 may interface with remote sites or networks via wired or wireless connections.

Control logic 1328 may be transmitted to and from computer 1300 via the communication medium 1322.

Any apparatus or manufacture comprising a computer useable or readable medium having control logic (software) stored therein is referred to herein as a computer program product or program storage device. This includes, but is not limited to, computer 1300, main memory 1308, secondary storage devices 1310, and removable storage unit 1316. Such computer program products, having control logic stored therein that, when executed by one or more data processing devices, cause such data processing devices to operate as described herein, represent embodiments of the invention.

Any apparatus or manufacture comprising a computer useable or readable medium having control logic (software) stored therein is referred to herein as a computer program product or program storage device. This includes, but is not limited to, a computer, computer main memory, secondary storage devices, and removable storage units. Such computer program products, having control logic stored therein that, when executed by one or more data processing devices, cause such data processing devices to operate as described herein, represent embodiments of the inventive techniques described herein.

### IX. Conclusion

While various embodiments have been described above, it should be understood that they have been presented by way of example only, and not limitation. It will be apparent to persons skilled in the relevant art that various changes in form and detail can be made therein without departing from the spirit and scope of the embodiments. Thus, the breadth and scope of the embodiments should not be limited by any of the above-described exemplary embodiments, but should be defined only in accordance with the following claims and their equivalents.

What is claimed is:

1. A system, comprising:
an event detector that:
receives a first signal, and
detects a first event based on an analysis of the first signal; and
a microphone control component that:
determines to enable processing of audio captured by a first microphone of a listening device based at least on the detected first event, and
responsive to the determination, transmits a first command to the listening device, the first command including instructions to enable processing of the audio captured by the first microphone.

2. The system of claim 1, wherein the first signal comprises at least one of:
a media content signal that is provided to a media presentation device that presents media content based on the media content signal;
an audio signal captured by a second microphone that is proximate to the media presentation device;
a network signal received by a network interface; or
an image or a video of the media presentation device captured by a camera.

3. The system of claim 1, wherein the transmission of the first command to the listening device causes the listening device to provide power to the first microphone to cause the first microphone to capture the audio; and
the system comprises an interface that receives, from the listening device, the audio captured by the first microphone.

4. The system of claim 1, wherein the transmission of the first command to the listening device causes the listening device to provide audio captured by the first microphone to an application executing on a network device for processing thereof.

5. The system of claim 1, wherein the event detector is further configured to:
compare an audio signal captured by the first microphone to an expected audio output of a media presentation device;
determine a level of similarity between the audio signal and the expected audio output meets a threshold condition;
in response to the level of similarity being determined to meet the threshold condition, determine that processing of the audio captured by the first microphone is enabled.

6. The system of claim 1, wherein the event detector is further configured to:
compare an audio signal captured by the first microphone to an expected audio output of a media presentation device;
determine a level of similarity between the audio signal and the expected audio output does not meet a threshold condition;
in response to the level of similarity being determined to not meet the threshold condition, performing a corrective action.

7. The system of claim 1, wherein the detected first event comprises one of:
an incoming audio or video call;
an indication that an audio input feature of an application has been enabled;
a determination that an application is in a state to accept user input; or
launching of an application with audio input features.

8. The system of claim 7, wherein the detected first event comprises the incoming call; and
the event detector is further configured to:
receive, from the listening device, an audio signal captured by the first microphone while the first microphone is on; and
determine whether to accept the incoming call based at least on the audio signal.

9. The system of claim 1, wherein the listening device comprises at least one of:
a remote control device; or
a smart home device.

10. A method, comprising:
receiving a first signal;
detecting a first event based on an analysis of the first signal;
determining to enable processing of audio captured by a first microphone of a listening device based at least on the detected first event; and
responsive to said determining, transmitting a first command to the listening device, the first command including instructions to enable processing of the audio captured by the first microphone.

11. The method of claim 10, wherein the first signal comprises at least one of:
a media content signal that is provided to a media presentation device that presents media content based on the media content signal;
an audio signal captured by a second microphone that is proximate to the media presentation device;
a network signal received by a network interface; or
an image or a video of the media presentation device captured by a camera.

12. The method of claim 10, wherein said transmitting the first command to the listening device causes the listening device to:
provide power to the first microphone to cause the first microphone to capture the audio; and
the method further comprises:
receiving the audio captured by the first microphone from the listening device.

13. The method of claim 10, wherein said transmitting the first command to the listening device causes the listening device to:
provide audio captured by the first microphone to an application executing on a network device for processing thereof.

14. The method of claim 10, further comprising:
comparing an audio signal captured by the first microphone to an expected audio output of a media presentation device;
determining whether a level of similarity between the audio signal and the expected audio output meets a threshold condition;
in response to determining that the level of similarity between the audio signal and the expected audio output meets the threshold condition, determining that processing of the audio captured by the first microphone is enabled; and
in response to determining that the level of similarity between the audio signal and the expected audio output does not meet the threshold condition, performing a corrective action.

15. The method of claim 10, wherein the detected first event comprises one of:
an incoming audio or video call;
an indication that an audio input feature of an application has been enabled;
a determination that an application is in a state to accept user input; or
launching of an application with audio input features.

16. The method of claim 15, wherein the detected first event comprises the incoming call; and
the method further comprises:
receiving, from the listening device, an audio signal captured by the first microphone while the first microphone is on; and
determining whether to accept the incoming call based at least on the audio signal.

17. The method of claim 10, further comprising:
detecting a second event;
determining to cease processing audio captured by the first microphone based at least on the detected second event; and
transmitting a second command to the listening device, the second command including instructions to cease processing audio captured by the first microphone.

18. The method of claim 10, wherein the listening device comprises at least one of:
a remote control device; or
a smart home device.

19. A computer-readable storage medium having program instructions recorded thereon that, when executed by a processor circuit perform operations, the operations comprising:
receiving a first signal;
detecting a first event based on an analysis of the first signal;
determining to enable processing of audio captured by a first microphone of a listening device based at least on the detected first event; and
responsive to said determining, transmitting a first command to the listening device, the first command including instructions to enable processing of the audio captured by the first microphone.

20. The computer-readable storage medium of claim 19, wherein the first signal comprises at least one of:
a media content signal that is provided to a media presentation device that presents media content based on the media content signal;
an audio signal captured by a second microphone that is proximate to the media presentation device;
a network signal received by a network interface; or
an image or a video of the media presentation device captured by a camera.
